(19) United States
(12) Patent Application Publication
(10) Pub. No.: US 2026/0171450 A1
(43) Pub. Date: Jun. 18, 2026

(54) MACHINE LEARNING-BASED DEGRADATION OPTIMIZATION FRAMEWORK

(71) Applicant: C3.ai, Inc., Redwood City, CA (US)

(72) Inventors: Nevroz Sen, San Jose, CA (US); Tiger Huang, San Mateo, CA (US); Henrik Ohlsson, Redwood City, CA (US); Francesco Zerbato, Mountain View, CA (US); Brett Stewart, La Grange Park, IL (US)

(21) Appl. No.: 19/418,832

(22) Filed: Dec. 12, 2025

Related U.S. Application Data
(60) Provisional application No. 63/733,434, filed on Dec. 12, 2024.

(51) Int. Cl. H01M 8/04664; G05B 13/02; H01M 8/04992; H01M 8/12; H01M 10/48; H02J 1/08

(52) U.S. Cl. CPC H01M 8/04664; G05B 13/027; H01M 8/04992; H01M 10/48; H02J 1/08; H01M 2008/1293; H01M 2220/20; H01M 2250/20

(57) ABSTRACT

Techniques for machine learning-based degradation optimization are disclosed. In embodiments, a method includes identifying a power module, wherein the power module is controlled with a set of variables; determining, using functional relations of degradation of a degradation machine learning model, optimal set-point values that minimize degradation of the power module while utilizing minimal resources; and reducing a degradation rate of the power module by adjusting one or more of the variables that control the power module based on the determined optimal set-point values.

### TECHNICAL FIELD

The present disclosure relates broadly to machine learning technology.

### BACKGROUND

Although some power modules include extremely promising energy conversion technologies, there has been limited commercial usage of these systems, mainly due to their relatively fast degradations.

### BRIEF DESCRIPTION OF DRAWINGS

FIG. 1 depicts a diagram of an example machine learning-based degradation optimization system according to some embodiments;

FIG. 2 depicts a flowchart of an example of a method of machine learning-based degradation optimization according to some embodiments;

FIG. 3 depicts a flowchart of an example of a method of machine learning-based degradation optimization for any number of power modules according to some embodiments;

FIG. 4 depicts a system flow and architecture of an example machine learning-based degradation optimization system according to some embodiments;

FIG. 5 depicts a diagram of an example single solid oxide fuel cell overview according to some embodiments;

FIG. 6 depicts a diagram of an example energy server architecture according to some embodiments;

FIG. 7 depicts a diagram of an example of a computing device according to some embodiments;

FIG. 8 illustrates an example system to perform one or more operations, in accordance with at least one embodiment;

FIG. 9 illustrates an example device supporting one or more operations, in accordance with at least one embodiment;

FIG. 10 illustrates training and deployment of a deep neural network, in accordance with at least one embodiment;

FIG. 11 illustrates an example training process of a generative model, according to at least one embodiment;

FIG. 12 illustrates an example of reinforcement learning, according to at least one embodiment;

FIG. 13 is a block diagram of an example generative language model system suitable for use in implementing one or more operations, in accordance with at least one embodiment;

FIG. 14 is a block diagram of an example implementation in which the generative language model (LM) includes a transformer encoder-decoder, in accordance with at least one embodiment;

FIG. 15 is a block diagram of an example implementation in which the generative language model (LM) includes a decoder-only transformer architecture, in accordance with at least one embodiment;

FIG. 16 depicts a diagram of an example agentic system, in accordance with at least one embodiment;

FIG. 17 depicts a diagram of an example layered architecture and environment of an artificial intelligence system, in accordance with at least one embodiment;

### DETAILED DESCRIPTION

In the following description, numerous specific details are set forth to provide a more thorough understanding of at least one embodiment. However, it will be apparent to one skilled in the art that the inventive concepts may be practiced without one or more of these specific details.

A novel machine learning-based degradation optimization framework is disclosed herein which is directed to predicting and reducing the degradation rate of various types of power modules and power sources. Notably, some power modules include extremely promising energy conversion technologies; however, they still have not been widely adopted due to long-term instability and relatively fast degradation dynamics. Currently, this degradation problem is considered one of the difficult technical problems to overcome during the actual deployment and operation of power modules. Consequently, there has been an extensive amount of work dedicated to understanding, controlling, and minimizing the degradation rate of power modules. However, traditional techniques cannot accurately predict degradation rates and cannot efficiently or effectively reduce degradation rates in order to provide reliable and durable system designs.

This disclosure introduces a machine learning-based degradation optimization framework designed specifically to address the degradation problem in order to provide reliable and durable system designs for different types of power modules that have previously been unreliable. In particular, the machine learning-based degradation optimization framework includes a data-driven decision-making framework which utilizes historical sensor and operation data in order to learn the relationships among system set-points and the induced physical degradation. This learned relationship is later consumed by a mathematical optimization framework that determines the optimal operating conditions (i.e., the set-points) given the current state of a power module and the constraints of the site that it collectively operates. For example, some key operation parameters are the fuel utilization, temperature, and current, which directly impact the efficiency and longevity of the power modules.

More specifically, the machine learning-based degradation optimization framework disclosed herein includes several machine learning models that learn the underlying degradation dynamics as a time varying function of the operating parameters of the power modules. Degradation dynamics can include, for example, Area Specific Resistance (ASR), also referred to as ohmic loss growth, as the main proxy for degradation which the framework can decompose into irreducible (or, irreversible) and instantaneous components.

In one example, a power module can contain hundreds of sensor measurements with many set-points (or, operating parameters) to control these devices. Furthermore, providers can manage thousands of power modules running at different sites under different environmental and other external conditions. Traditional practices often depend heavily on manual or ad-hoc testing, as well as subject matter expert (SME) knowledge to determine the optimal operating conditions for an individual power module. The problem quickly becomes non-tractable once there are multiple power modules (e.g., whose operating conditions depend on the site level conditions). Therefore, without having a rigorous learning and optimization framework, operators can only analyze and act on a very small subset of power modules where, in most cases, important signals are not caught due to the lack of data-driven learning mechanisms. This disclosure provides both functionalities in one unified framework.

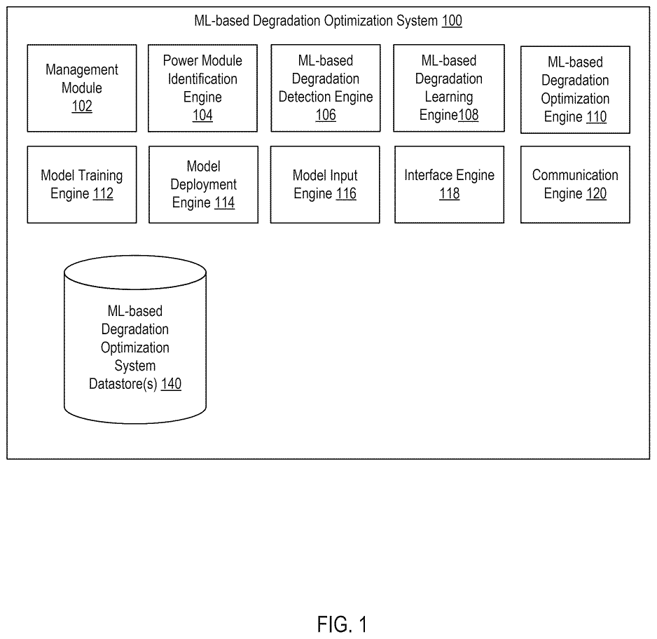

FIG. 1 depicts a diagram of an example machine learning-based degradation optimization system 100 according to some embodiments. In the example of FIG. 1, the machine learning-based degradation optimization system 100 includes a management engine 102, a power module identification engine 104, a machine learning-based degradation detection engine 106, a machine learning-based degradation learning engine 108, a machine learning-based degradation optimization engine 110, a model training engine 112, a model deployment engine 114, a model input engine 116, an interface engine 118, a communication engine 120, and a machine learning-based degradation optimization system datastore 130.

The management engine 102 can function to manage (e.g., create, read, update, delete, or otherwise access) data associated with the machine learning-based degradation optimization system 100. The management engine 102 may manage some or all of the of the datastores described herein (e.g., machine learning-based degradation optimization system datastore 130) and/or in one or more other local and/or remote datastores. It will be appreciated that datastores may be single or multiple datastores local to the machine learning-based degradation optimization system 100 and/or single or multiple datastores remote from the machine learning-based degradation optimization system 100. The datastores described herein may comprise one or more local and/or remote datastores. The management engine 102 may perform operations manually (e.g., by a user interacting with a GUI generated by the interface engine 118) and/or automatically (e.g., triggered by one or more of the engines 104-120). Like other engines described herein, some or all the functionality of the management engine 102 may be included in and/or cooperate with one or more other engines, modules, services, systems, and/or datastores.

In some embodiments, the management engine 102 can manage, integrate, and/or normalize disparate data from disparate data sources. For example, the management engine 102 may integrate various types of data from disparate data sources having different data formats, and the like. The data may include sensor data, time-series data (e.g., time-series data detected by various sensors), real-time or live data, historical data (e.g., historical sensor data), analytics (e.g., predicted degradation, predicted optimizations), and the like. The management engine 102 may use predefined integration rules to integrate and/or normalize some or all of the data described herein.

The power module identification engine 104 can function to identify one or more power modules. In some implementations, the power module identification engine 104 identifies power modules that are capable of being optimized by the machine learning-based degradation optimization system 100. For example, the power module identification engine 104 can identify any number of power modules that can potentially degrade over time (e.g., power modules that include electrochemical components). This can help increase efficiency of the machine learning-based degradation optimization system 100 by not attempting to optimize every type of power module. As used herein, a power module can include one or more (e.g., arrays, fields, stacks) power cells, fuel cells, batteries, and/or other power sources. Power modules can include solid oxide fuel cells (SOFCs), SOFC system stacks, and/or other types of system stacks.

The machine learning-based degradation detection engine 106 can function to detect changes to variable values and/or set-point values over time. For example, the values may change differently for various power modules, even if they are the same type of power module. Variables can include temperature, current, voltage, fuel, air, geographic location, etc. Variables can include decision variables and/or target variables.

The most widely used proxy for determining the degradation of power modules (e.g., SOFC stacks) is the Area Specific Resistance (ASR), which is the resistance offered by unit area of a cell. In practice, this quantity is calculated using multiple measurements from the power module and might slightly differ for each manufacturer, however, each still closely follows the following equations:

$$V = {N}_{cells} ( {V}_{OC} - {η}_{o h m} - {n}_{act} - {n}_{c o n} ) \qquad ( 1 )$$

where V_{OC} is the open circuit voltage (which can be a function of system parameters), where N is the number of cells, V represents the cell voltage, ηₒₕₘ, n_{act} and n_{con} are the ohmic polarization voltage, the activating polarization voltage and the concentration polarization loss voltage of the stack, respectively. ASR can then be calculated using the current density

$${η}_{ohm} + η act + η con = \frac{I}{A} R \qquad ( 2 )$$

where I is the stack current and A is the area. The unit of measure for ASR is Ωcm². During the lifetime of SOFC power modules (PMs), ASR increases as a result of the physical degradation induced by the complex relation among the operating conditions.

However, ASR contains information both from the historical actions and the current control settings. The former is referred to as the irreducible or irreversible degradation, which one is interested to minimize at each time instant. Next this target is defined.

Consider V, and let Vₜ and Vₜ₊₁₀₀₀ denote the cell voltage measurements at time t and t+1000 hours.

The number 1000 is widely accepted and used unit in measuring degradation. Degradation rate is defined as follows:

$${r}_{d} = ( {V}_{t} - {V}_{t + 1000} ) / {V}_{t} \qquad ( 3 )$$

which, under normal operating conditions, should be strictly positive. The overall goal is then to minimize r_{d} for each segment of each power module which can be formulated as follows.

Consider a site which is configured with N PMs where each PM contains multiple stacks of SOFCs. Each SOFC stack is controlled with a set of variables such as fuel gas flow, air flow, temperature, in addition to a set of variables controlled at the PM level. The system can consider the following steps:
a. Develop an ML model predicting the degradation of each individual PMs
b. Using this ML model's functional relations to determine the optimal set point values that minimizes the degradation of each stack at the PM while utilizing minimum resources, say natural gas, and satisfying the service requirement at a site level.

The machine learning-based degradation learning engine 108 can function to learn (e.g., by a degradation machine learning model), based on the detected changes over time, how variable values affect degradation differently for the various power modules. In some embodiments, the machine learning-based degradation learning engine 108 can function to generate a respective digital twin for each of the power modules. The digital twins can include a library of different machine learning models associated with different operating conditions of the power modules. The learning can then be performed based on the digital twins. In one example, each power module may have one or more assigned machine learning models that predicts degradation rate for that power module, and/or performs other functionality described herein.

In one example, assume a site Sis given with M power modules (PMs). For simplicity, assume that each PM has the same number of segments, N (e.g., 4), and can generate the same maximum power Pₘₐₓ. Consequently, the following notation is introduced:
xᵢⱼₖ∈R₊, i∈Vₛ, j∈N, k∈K: Set point i of stack j of PM k.
yₗⱼ∈R₊, l∈Vₚ, j∈N: Set point l of PM j.
sᵢⱼₖ∈R₊, j∈N, k∈K: Sensor i of stack j of PM k.
Pₜ, site level power constraint at time t∈[0, T].
Eₜ, site level constraint at time t∈[0, T].
Φ_{i,j}: R^{|S|+|V}^{_{S}}^{|+|V}^{_{P}}^{|}→R₊, learned mapping between the sensor measurements and set-points to degradation for the segment i, 1≤i≤N, of power module j, 1≤i≤M.
φᵢ: R^{|S|+|V}^{_{S}}^{|+|V}^{_{P}}^{|}→R₊, learned mapping between the sensor measurements and set-points to instantaneous ASR for the segment i, 1≤i≤N, of power module j, 1≤i≤M.
Xᵢⱼₖ, Yᵢⱼ, the range of possible values for x and y set-points, respectively.

Note that x and y should be considered as the decision variables to be optimized for.

The first step of the optimization problem is to introduce an objective function that represents a relation between the set-points to the degradation. As mentioned above, this can be completed in two steps: where in the first step, the relation of the irreducible degradation r_{d} defined above is learned.

Let r_{d}(t), 0≤t≤Tₜᵣ for Tₜᵣ<T is given. The learning problem is then to find a functional relation between the decision variables and r_{d}. However, the system and/or system users may need to be extremely careful here due to the following two reasons: (i) The relation should explain the underlying physical reality and (ii) The relation should be relatively simple in order to have a tractable optimization problem that can be solved in a reasonable time. The former is essential for the adaptation of the solution whereas the latter is essential for the practicability purposes; a user might want to simulate and compare multiple operating scenarios.

Therefore, the system can consider a subset of variables and search the optimal parameters for an assumed functional form. The system has the following:

$${Φ}_{j , k} = ( {α}_{j , k}^{1} {x}_{futil , j , k} {β}_{j , k}^{1} ) * ( {α}_{j , k}^{2} exp ( {x}_{temp , j , k} ) {β}_{j , k}^{2} ) * ( {α}_{j , k}^{3} {x}_{cur , j , k} / {A}_{j , k} {β}_{j , k}^{3} ) + {α}_{j , k}^{4} exp ( \sqrt{{x}_{temp , j , k}} ) {β}_{j , k}^{4} + {α}_{j , k}^{5} {x}_{anrec , j , k} {β}_{j , k}^{5} \qquad ( 4 )$$

where A_{j,k} denote the area of stack j of PM k, temp, cur, futil and anrec represent stack temperature, stack current, stack fuel utilization, and power module anode recycle rates, and α and β represents the coefficients to be learned, and before going to the details of how the system learns those values. There has been an extensive amount academic and experimental work to determine the relationship between set-points and degradation. The structure in (4) is motivated by such results, where the system further improved the relation by incorporating underlying physical relations. Consequently, the learning problem reduces to, for each j, k,

$${min}_{{α}_{j , k}^{i} , {β}_{j , k}^{i} , 1 \leq i \leq 5} \frac{1}{{T}_{1000}} {\sum }_{t = 1}^{{T}_{1000}} {‖ {Φ}_{j , k} ( t ) - {r}_{d , j , k} ( t ) ‖}^{2} \qquad ( 5 )$$

where the sum goes over all 1000 hrs sample points, a standard benchmark in industry.

Once those parameters are learned, the system can then calculate/predict the irreducible and instantaneous ASR as follows. Let

$${\{ {α}_{j , k}^{i} \text{?} , {\hat{β}}_{j , k}^{i} \}}_{j = 1 , … , N , k = 1 , … , M}$$

$$\text{?} \text{indicates text missing or illegible when filed}$$

denote the solution to (5). It is given as:

$${R}_{j , k}^{irr} ( t ) = {\sum }_{s = 0}^{t} {R}_{j , k} ( 0 ) {\hat{r}}_{d , j , k} ( s ) / 1000 \qquad ( 6 )$$

where \hat{r}_{d} is calculated at

$${\{ {α}_{j , k}^{i} \text{?} , {\hat{β}}_{j , k}^{i} \}}_{i = 1 , … , 5}$$

$$\text{?} \text{indicates text missing or illegible when filed}$$

in ( [symbol] ).

Finally, we simulate and predict the ASR by using the optimal values together with

$${R}_{j , k}^{irr}$$

defined in ( [symbol] ) as follows.

$${\hat{V}}_{i , j} ( t ) = {V}_{j , k}^{0} ( t ) ( 1 - {r}_{d , j , k} \text{?} ( t ) ) \qquad ( 7 )$$

$${\hat{R}}_{i , j} ( t ) = ( {V}_{OC} ( t ) - {V}_{i , j} \text{?} ( t ) ) / {i}_{j , k} ( t ) .$$

$$\text{?} \text{indicates text missing or illegible when filed}$$

Remark that equation (7) can be used to simulate scenario trajectories for each set-point consideration. The optimization features are discussed below.

The machine learning-based degradation optimization engine 110 can function to determine, using functional relations of the degradation machine learning model, optimal set-point values that minimize an overall degradation of the plurality of power modules while utilizing minimal resources.

In some embodiments, the machine learning-based degradation optimization engine 110 can function to reduce the overall degradation rate of the plurality of power modules by adjusting one or more of the respective sets of variables that control the power modules based on the determined optimal set-point values. Reducing the overall degradation can include removing one or more of the power modules from the plurality of power modules.

In some embodiments, the machine learning-based degradation optimization engine 110 can function to predict, by the degradation machine learning model based on historical variable values, a respective rate of degradation for each of the power modules.

Once the optimal parameters are learned (e.g., equation 4, above), the system can introduce an optimization framework to find the optimal set-points. However, in some embodiments, the system cannot (and/or does not) arbitrarily optimize such; variables that r_{d} depends upon should satisfy a set of constraints both at a segment, at a power module and at a site level. Among these, the system leverages the latter to improve the median life by operating and/or optimizing the power modules which are close to their end of life.

Considering all the aspects, the system formulates the following optimization problem:

$$\text{?} {λ}_{1} {\sum }_{j = 1}^{N} {\sum }_{k = 1}^{M} {Φ}_{j , k}^{ML} ( {x}_{temp , j , k} , x \text{?} , x \text{?} ) - {λ}_{2} {\sum }_{j = 1}^{N} {\sum }_{k = 1}^{M} {Pow}_{j , k} ( {x}_{temp , j , k} , x \text{?} , x \text{?} ) - {λ}_{3} {\sum }_{k = 1}^{M} {Eff}_{k} ( {x}_{temp} , {x}_{futil} , x \text{?} {x}_{fuel} ) + {λ}_{4} {\sum }_{k = 1}^{M} {max}_{j} {Φ}_{j , k}^{ML} ( {x}_{temp , j , k} , {x}_{futil , j , k} , {x}_{cur , j , k} ) + {\sum }_{j = 1}^{N} {\sum }_{k = 1}^{M} ξ \text{?} ( {x}_{temp , j , k} , {x}_{futil , j , k} , {x}_{cur , j , k} ) \qquad ( 8 )$$

$$such that \qquad ( 9 )$$

$${LB}_{temp , j , k} \leq {x}_{temp , j , k} ( t ) \leq {UB}_{temp , j , k} \qquad ( 10 )$$

$$LB \text{?} \leq x \text{?} ( t ) \leq UB \text{?} \qquad ( 11 )$$

$${LB}_{cur , j , k} \leq {x}_{cur , j , k} ( t ) \leq {UB}_{cur , j , k} \qquad ( 12 )$$

$$LB \text{?} \leq x \text{?} ( t ) \leq UB \text{?} \qquad ( 13 )$$

$$LB \text{?} \leq {x}_{fuel , d , k} ( t ) \leq {UB}_{fuel , d , k} \qquad ( 14 )$$

$${T}_{max}^{k} ( t ) = ML ( {x}_{temp , k} ( t ) , x \text{?} ( t ) , {x}_{cur , k} ( t ) , x \text{?} ( t ) ) \qquad ( 15 )$$

$${x}_{temp , j , k} ( i ) \leq {T}_{max} \qquad ( 16 )$$

$${x}_{cur , k}^{tot} ( t ) = ML ( \text{?} , totalcells , fuelparms ) \qquad ( 17 )$$

$$x \text{?} ( t ) = ML ( \text{?} ) \qquad ( 18 )$$

$${x}_{fuel , d , k} ( i ) = ML ( totalcells , fuelparams , {x}_{cur , j , k} ( t ) , {x}_{futil , k} ( t ) ) \qquad ( 19 )$$

$$x \text{?} ( t ) = ML ( \text{?} ) \qquad ( 20 )$$

$$x \text{?} ( t ) = ML ( \text{?} ) \qquad ( 21 )$$

$${μ}_{j , k} ( t + 1 ) = ξ \text{?} ( {μ}_{j , k} ( t ) , {μ}_{j , k} ( t - 1 ) , {μ}_{j , k} ( t - 2 ) , x \text{?} ( t ) , x \text{?} ( t ) , \text{?} \qquad ( 22 )$$

$${max}_{p , r} ( {x}_{cur , p , k} ( t ) - {x}_{cur , r , k} ( t ) ) \leq {Δ}_{cur} \qquad ( 23 )$$

$$\frac{1}{M} {\sum }_{k = 1}^{M} {\sum }_{j} {{x}_{cur , j , k} ( t )}^{2} {R}_{i , j} ( t ) \geq {λ}_{p} P \qquad ( 24 )$$

$$\frac{1}{M} {\sum }_{k = 1}^{M} {\sum }_{j} \frac{{{x}_{cur , j , k} ( t )}^{2} {R}_{i , j} ( t )}{x \text{?}} \geq λ \text{?} E \qquad ( 25 )$$

$$x \text{?} ( t ) = ML ( totalcells , fuelparams , {x}_{fuel , k} ( t ) , {x}_{futil , k} , {x}_{cur , k} ( t ) , \text{?} ( t ) ) \qquad ( 26 )$$

$$x \text{?} ( t ) \geq OC \qquad ( 27 )$$

$${T}_{tr} < t \leq T \qquad ( 28 )$$

$$\text{?} \leq j \leq N , 1 \leq k \leq M \qquad ( 29 )$$

$$\text{?} \text{indicates text missing or illegible when filed}$$

where (9-12) are the lower and upper bounds for the setpoints variables, (14) is the maximum stack temperature constraint, (18) is the connection constraint between read-back variables and futil set-point, (22) is the max difference constraint across segment currents, (23)-(24) guarantees site level power and efficiency requirements, (21) predicts the sensitivity in the next time step and (26) satisfies the oxygen to carbon ration which depends on the system variables together with the fuel and the stack design parameters. The objective function tries to minimize total degradation, max degradation of each power modules, maximize power and efficiency and minimize expected sensitivity in the next time step.

The model training engine 112 can function to capture feedback regarding model performance (e.g., response time), model accuracy, system utilization (e.g., model processing system utilization, model processing unit utilization), and other attributes. For example, the model training engine 112 may track user interactions within systems, capturing explicit feedback (e.g., through a training user interface), implicit feedback, and the like. The feedback may be used to refine models (e.g., by the model training engine 112).

The model training engine 112 can be used to enable model tuning. For example, the model training engine 112 may tune models based on tracking user interactions within the system, capture explicit feedback (e.g., through a training user interface), implicit feedback, etc. In some example implementations, the model training engine 112 may optionally be used to accelerate knowledge base bootstrapping. Reinforcement learning may be used for explicit bootstrapping of the system with instrumentation of time spent, results clicked on, etc. Example aspects include an innovative learning framework that may bootstrap models for different enterprise environments. Example aspects include an innovative learning framework that may bootstrap models for different enterprise environments.

The model training engine 112 can function to train, retrain, tune, and/or refine the models described herein. For example, models can be trained and/or fine-tuned via transfer learning techniques on feedback, updated sensor readings, etc. The model training engine 112 can function to retrain any of the machine learning models to capture latest or current variable values and learn from the changes to the variable values over time.

The model deployment engine 114 may function to obtain, generate, and/or modify some or all of the different types of models described herein (e.g., machine learning models, large language models, data models, multimodal models). In some implementations, the model deployment engine 114 may use a variety of machine learning techniques or algorithms to generate models. As used herein, artificial intelligence and/or machine learning may include Bayesian algorithms and/or models, deep learning algorithms and/or models (e.g., artificial neural networks, convolutional neural networks), gap analysis algorithms and/or models, supervised learning techniques and/or models, unsupervised learning algorithms and/or models, semi-supervised learning techniques and/or models random forest algorithms and/or models, similarity learning and/or distance algorithms, generative artificial intelligence algorithms and models, clustering algorithms and/or models, transformer-based algorithms and/or models, neural network transformer-based machine learning algorithms and/or models, reinforcement learning algorithms and/or models, and/or the like. The algorithms may be used to generate the corresponding models. For example, the algorithms may be executed on datasets (e.g., domain-specific data sets, enterprise datasets) to generate and/or output the corresponding models.

In some embodiments, a large language model is a deep learning model (e.g., generated by a deep learning algorithm) that may recognize, summarize, translate, predict, and/or generate text and other content based on knowledge gained from massive datasets. Large language models may comprise transformer-based models. Large language models can include Google's Gemini, OpenAI's GPT, Anthropic Claude, Microsoft's Transformer, among others. Large language models can process vast amounts of data, leading to improved accuracy in prediction and classification tasks. The large language models can use this information to learn patterns and relationships, which can help them make improved predictions and groupings relative to other machine learning models. Large language models can include artificial neural network transformers that are pre-trained using supervised and/or semi-supervised learning techniques. In some embodiments, large language models comprise deep learning models specialized in text generation. Large language models, in some embodiments, may be characterized by a significant number of parameters (e.g., in the tens or hundreds of billions of parameters) and the large corpuses of text used to train them.

The model input engine 116 can function to obtain, generate, and provide model inputs (e.g., to any of the models described herein). The model input engine 116 may also use different model configurations and/or feature configuration for model inputs. More specifically, features can be pre-specified transformations of data that are relevant to modeling resources using data described herein. In some embodiments, features can be defined by end users through systems (e.g., through a graphical user interface generated by interface engine 118). More specifically, the approach can be simplified by identifying the underlying data used in the feature transformations through identifiers or descriptions of that data.

Feature assignment to models can also be manual and/or automatic. Once features are assigned to a model, they can be used in training (e.g., by the machine learning-based degradation optimization system 100) based on the availability of underlying data (e.g., feature(s) can be excluded if the underlying data is insufficient or absent), and/or an importance (e.g., relative value) to the models through different techniques (e.g., forward feature selection, leave-one-out, etc.), and features can be included based on an extent to which they contribute to model accuracy.

The interface engine 118 can function to present, via a graphical user interface (GUI), model outputs (e.g., initial outputs, formatted and/or modified outputs, etc.). In some embodiments, the interface engine 118 can receive (e.g., from a user and/or system) feedback through the GUI associated with the formatted and modified output

The communication engine 120 can function to send requests, transmit and receive communications, and/or otherwise provide communication with one or more of the systems, engines, services, modules, registries, repositories, layers, devices, datastores, and/or other components described herein. In a specific implementation, the communication engine 120 may function to encrypt and decrypt communications. The communication engine 120 may function to send requests to and receive data from one or more systems through a network or a portion of a network. In a specific implementation, the communication engine 120 may send requests and receive data through a connection, all or a portion of which can be a wireless connection. The communication engine 120 may request and receive messages, and/or other communications from associated systems, engines, modules, layers, and/or the like. Communications may be stored in the machine learning-based degradation optimization system datastore 130.

In various embodiments, some or all of the engines described herein may use various machine learning models to perform the functionality described herein.

The techniques presented herein can be extended by considering other alternative learning models as well as:
Including additional set points in the prediction model and consequently in the optimization
Including additional sensor measurements and features utilizing the variance across segments and cells—an individual bad cell in a stack makes that stack to degrade faster
Relax and explore alternative functional forms

In addition, some other alternative approaches can be summarized as follows:
Changing target variable from r_{d} to the rate of difference of the power or efficiency and relax the monotone assumption of the target
Introducing additional machine learning models or physics model to address other physical degradation mechanisms, including but not limited to, fuel sensitivity, sulphur poisoning and similar.
A dynamical system approach; in this case, the system formulates the following, for a given target θ

$$θ ( t + 1 ) = f ( θ ( t ) , u ( t ) ) \qquad ( 30 )$$

where uₜ∈Rⁿ is the controls and for simplicity, f can be assumed to be linear.

$$min \text{?} {λ}_{1} {\sum }_{j = 1}^{4} {\sum }_{k = 1}^{M} {Φ}_{j , k} ( t ) + {λ}_{2} {\sum }_{k = 1}^{M} {Pow}_{j , k} ( t ) + {λ}_{3} {\sum }_{k = 1}^{M} {Eff}_{j , k} ( t ) + {λ}_{4} {\sum }_{k = 1}^{M} \text{?} {Φ}_{j , k} ( t ) \qquad ( 31 )$$

$$\text{?} \text{indicates text missing or illegible when filed}$$

The techniques presented in this disclosure are applicable to other battery and power module optimization which might have different operating parameters to consider. The overall approach is capable of considering a large class of linear and nonlinear dynamics where generalization to other cases essentially entails learning the functional form and the coefficients.

For instance, it is well known that temperature, depth-of-charge, and state-of-charge are three critical operating parameters that determine the age of Lithium-ion batteries. With regards to the temperature, similar to SOFCs, high temperatures speed up chemical degradation and similar to SOFCs, the interconnection between temperature and aging is non-linear with small increases leading to significant reductions in lifetime, where it is believed that an increase in temperature by 10 Kelvin can halve a battery's lifetime.

The impact of aging varies depending on the state-of-charge ranges where the battery operation is concentrated and once again, similar to SOFC, this impact is a function of time and can be learned by using ML models and historical values.

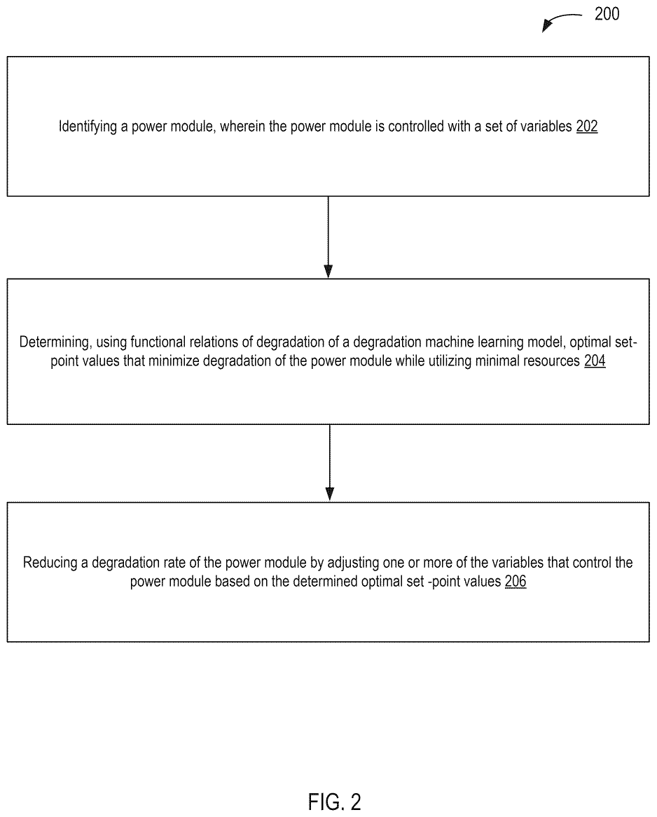

FIG. 2 depicts a flowchart 200 of an example of a method of machine learning-based degradation optimization according to some embodiments. In this and other flowcharts and/or sequence diagrams, the flowchart illustrates by way of example a sequence of steps. It should be understood that some or all of the steps may be repeated, reorganized for parallel execution, and/or reordered, as applicable. Moreover, some steps that could have been included may have been removed to avoid providing too much information for the sake of clarity and some steps that were included could be removed but may have been included for the sake of illustrative clarity.

In step 202, a computing system (e.g., machine learning-based degradation optimization system 100) identifies a power module. The power module may be controlled with (or, by) a set of variables (and/or associated variable values). In some embodiments, a power module identification engine (e.g., power module identification engine 104) performs the identification.

In step 204, the computing system determines, using functional relations of degradation of a degradation machine learning model, optimal set-point values that minimize degradation of the power module while utilizing minimal resources. In some embodiments, a machine learning-based degradation optimization engine (e.g., machine learning-based degradation optimization engine 110) determines the optimal set-point values.

In step 206, the computing system reduces a rate of degradation of the power module by adjusting one or more of the variables that control the power module based on the determined optimal set-point values. In some embodiments, the machine learning-based degradation optimization engine reduces the rate of degradation.

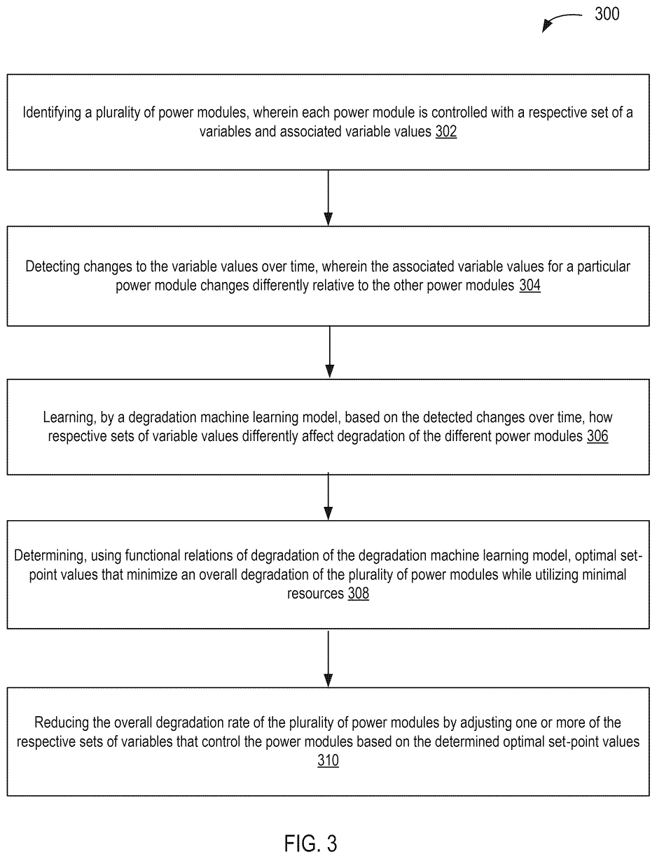

FIG. 3 depicts a flowchart 300 of an example of a method of machine learning-based degradation optimization for any number of power modules according to some embodiments.

In step 302, a computing system (e.g., machine learning-based degradation optimization system 100) identifies a plurality of power modules. Each power module may be controlled with (or, by) a respective set of a variables and associated variable values (e.g., time-series values). The power modules may be the same type of power module (e.g., a homogeneous set of power modules) and/or different type of power modules (e.g., heterogenous set of power modules). In some embodiments, a power module identification engine (e.g., power module identification engine 104) performs the identification.

In step 304, the computing system detects changes to the variable values over time, wherein the associated variable values for a particular power module changes differently relative to the other power modules. In some embodiments, a machine learning-based degradation detection engine (e.g., machine learning-based degradation detection engine) detects the changes.

In step 306, the computing system learns, by a degradation machine learning model, based on the detected changes over time, how respective sets of variable values differently affect degradation of the different power modules. In some embodiments, a machine learning-based degradation learning engine (e.g., machine learning-based degradation learning engine 108) learns how the respective sets of variable values differently affect degradation of the different power modules.

In step 308, the computing system determines, using functional relations of degradation of the degradation machine learning model, optimal set-point values that minimize an overall degradation of the plurality of power modules while utilizing minimal resources. In some embodiments, a machine learning-based degradation optimization engine (e.g., machine learning-based degradation optimization engine 110) determines the optimal set-point values.

In step 310, the computing system reduces the overall degradation rate of the plurality of power modules by adjusting one or more of the respective sets of variables that control the power modules based on the determined optimal set-point values. In some embodiments, the machine learning-based degradation optimization engine reduces the overall degradation rate of the plurality of power modules.

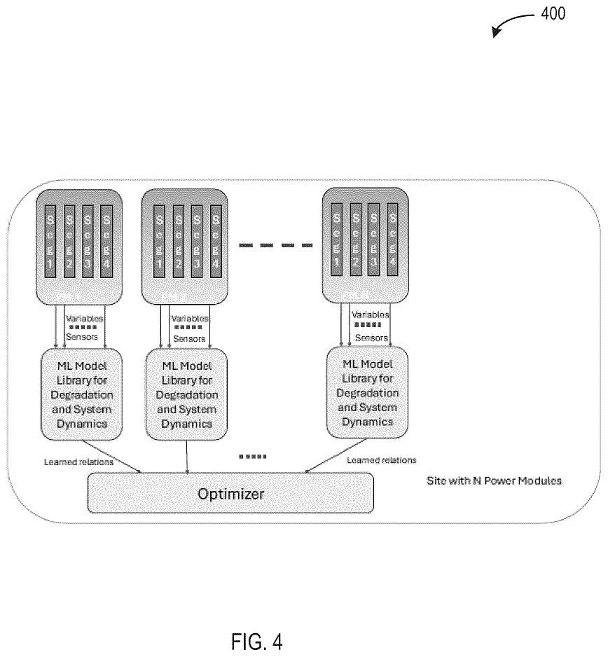

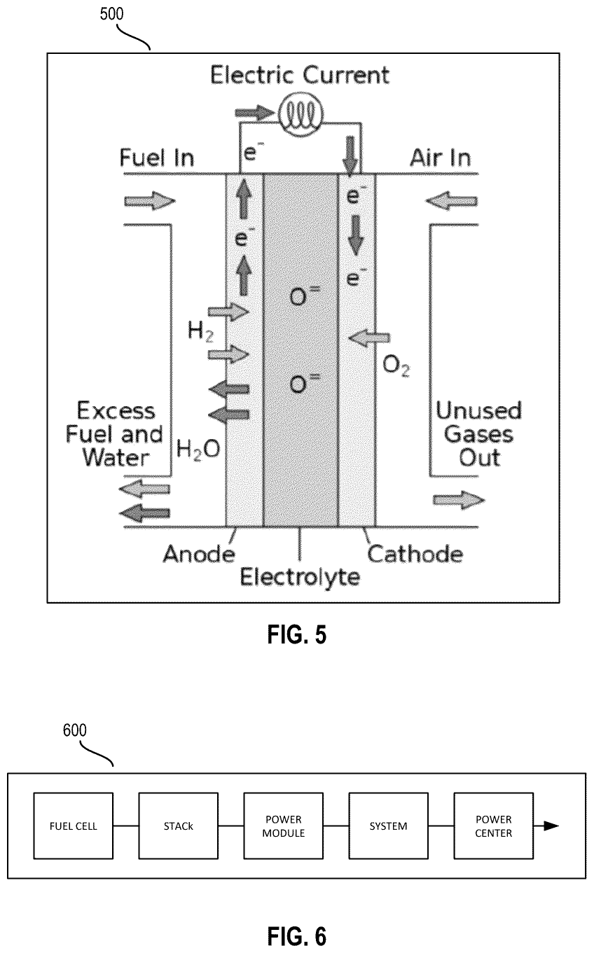

FIG. 4 depicts a system flow and architecture 400 of an example machine learning-based degradation optimization system according to some embodiments. FIG. 5 depicts a diagram of an example single SOFC overview according to some embodiments. As discussed briefly above, by electrochemically reacting fuel with oxygen ions harvested from the ambient air, SOFCs produce energy. A single SOFC contains three layers of solid materials; an anode, a cathode and an electrolyte which are connected via interconnect plates between these layers. A simple example is shown in FIG. 5.

A typical SOFC cell can produce 20-25 W of power and in order to satisfy higher power requirements, hundreds of these cells are then connected in series to form what is typically referred as an SOFC stack. In many industrial settings, such stacks are further connected in order to obtain even higher power requirements for complex, high energy demanding facilities. A system that connects multiple stacks is referred to as a power module (PM). The hierarchy goes further by connecting multiple power modules, referred to as a system (see FIG. 6).

FIG. 6 depicts a diagram of an example energy server architecture according to some embodiments. As used herein, reference to a “power module” may include one or more of the fuel cells, stacks, power modules, systems, and/or power centers depicted in FIG. 6. It will be appreciated that FIG. 6 is shown by way of example, and a “power module” may refer to another type of power source (e.g., battery) not shown in FIG. 6.

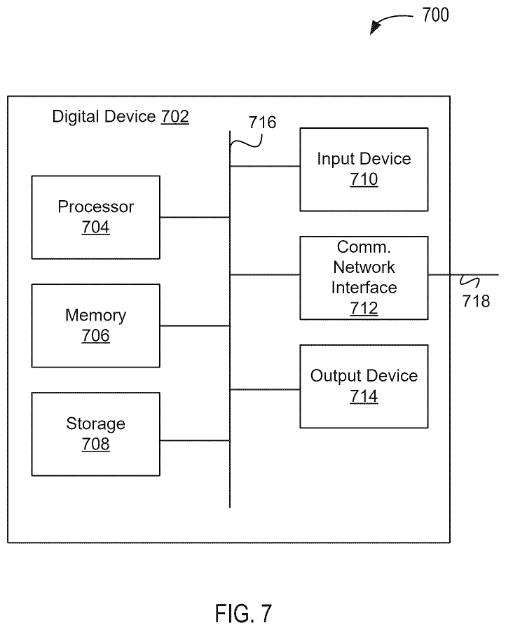

FIG. 7 depicts a diagram 700 of an example of a computing device 702. Any of the systems, engines, datastores, and/or networks described herein may comprise an instance of one or more computing devices 702. In some embodiments, functionality of the computing device 702 is improved to the perform some or all of the functionality described herein. The computing device 702 comprises a processor 704, memory 706, storage 708, an input device 710, a communication network interface 712, and an output device 714 communicatively coupled to a communication channel 716. The processor 704 is configured to execute executable instructions (e.g., programs). In some embodiments, the processor 704 comprises circuitry or any processor capable of processing the executable instructions.

The memory 706 stores data. Some examples of memory 706 include storage devices, such as RAM, ROM, RAM cache, virtual memory, etc. In various embodiments, working data is stored within the memory 706. The data within the memory 706 may be cleared or ultimately transferred to the storage 708.

The storage 708 includes any storage configured to retrieve and store data. Some examples of the storage 708 include flash drives, hard drives, optical drives, cloud storage, and/or magnetic tape. Each of the memory 706 and the storage 708 comprises a computer-readable medium, which stores instructions or programs executable by processor 704.

The input device 710 is any device that inputs data (e.g., mouse and keyboard). The output device 714 outputs data (e.g., a speaker or display). It will be appreciated that the storage 708, input device 710, and output device 714 may be optional. For example, the routers/switchers may comprise the processor 704 and memory 706 as well as a device to receive and output data (e.g., the communication network interface 712 and/or the output device 714).

The communication network interface 712 may be coupled to one or more networks via the link 718. The communication network interface 712 may support communication over an Ethernet connection, a serial connection, a parallel connection, and/or an ATA connection. The communication network interface 712 may also support wireless communication (e.g., 802.11 a/b/g/n, WiMax, LTE, WiFi). It will be apparent that the communication network interface 712 may support many wired and wireless standards.

It will be appreciated that the hardware elements of the computing device 702 are not limited to those depicted in FIG. 7. A computing device 702 may comprise more or less hardware, software, and/or firmware components than those depicted (e.g., drivers, operating systems, touch screens, biometric analyzers, and/or the like). Further, hardware elements may share functionality and still be within various embodiments described herein. In one example, encoding and/or decoding may be performed by the processor 704 and/or a co-processor located on a GPU (i.e., NVidia).

Example types of computing devices and/or processing devices include one or more microprocessors, microcontrollers, reduced instruction set computers (RISCs), complex instruction set computers (CISCs), graphics processing units (GPUs), data processing units (DPUs), virtual processing units, associative process units (APUs), tensor processing units (TPUs), vision processing units (VPUs), neuromorphic chips, AI chips, quantum processing units (QPUs), cerebras wafer-scale engines (WSEs), digital signal processors (DSPs), application specific integrated circuits (ASICs), field programmable gate arrays (FPGAs), or discrete circuitry.

According to some examples, a method includes identifying a power module, wherein the power module is controlled with a set of variables; determining, using functional relations of degradation of a degradation machine learning model, optimal set-point values that minimize degradation of the power module while utilizing minimal resources; and reducing a degradation rate of the power module by adjusting one or more of the variables that control the power module based on the determined optimal set-point values.

According to some examples, a method includes identifying a plurality of power modules, wherein each power module is controlled with a respective set of a variables and associated variable values; detecting changes to the associated variable values over time, wherein the associated variable values for a particular power module of the plurality of power modules changes differently relative to other power modules of the plurality of power modules; learning, by a degradation machine learning model, based on the detected changes over time, how respective sets of variable values differently affect degradation of different power modules of the plurality of power modules; determining, using functional relations of degradation of the degradation machine learning model, optimal set-point values that minimize an overall degradation rate of the plurality of power modules while utilizing minimal resources; and enabling reduction of the overall degradation rate of the plurality of power modules by adjusting one or more of the respective sets of variables that control the plurality of power modules based on the determined optimal set-point values.

According to some examples, a system includes one or more processors; and memory storing instructions that, when executed by the one or more processors, cause the system to perform: identifying a power module, wherein the power module is controlled with a set of variables; determining, using functional relations of degradation of a degradation machine learning model, optimal set-point values that minimize degradation of the power module while utilizing minimal resources; and enabling reduction of a degradation rate of the power module by adjusting one or more of the set of variables that control the power module based on the determined optimal set-point values.

According to some examples, a system includes one or more processors; and memory storing instructions that, when executed by the one or more processors, cause the system to perform: identifying a plurality of power modules, wherein each power module is controlled with a respective set of variables and associated variable values; detecting changes to the associated variable values over time, wherein the associated variable values for a particular power module changes differently relative to other power modules of the plurality of power modules; learning, by a degradation machine learning model, based on the detected changes over time, how respective sets of variable values differently affect degradation of different power modules of the plurality of power modules; determining, using functional relations of degradation of the degradation machine learning model, optimal set-point values that minimize an overall degradation rate of the plurality of power modules while utilizing minimal resources; and enabling reduction of the overall degradation rate of the plurality of power modules by adjusting one or more of the respective sets of variables that control the plurality of power modules based on the determined optimal set-point values.

Any such examples may include any or any combination of the following aspects. Each of the plurality of power modules are of a same type of power module. The plurality of power modules includes different types of power modules. The method also includes generating a respective digital twin for each of the plurality of power modules, wherein the digital twins comprise a library of different machine learning models associated with different operating conditions of the power modules, and wherein the learning is performed based on the digital twins. The method also includes retraining degradation machine learning models to capture latest or current variable values and learn from the changes to the associated variable values over time. The set of variables includes any of temperature, current, voltage, fuel, air, and/or geographic location. A power module comprises any of a power cell, battery, and other power source. The method also includes predicting, by the degradation machine learning model based on historical variable values, a respective rate of degradation for each of the plurality of power modules. Enabling reduction of the overall degradation rate of the plurality of power modules includes removing one or more of the plurality of power modules from the plurality of power modules. The plurality of power modules includes any number of power modules. Enabling reduction is at least partially performed by an optimizer. At least a portion of the associated variable values include time series values.

According to some examples, an apparatus may include means for performing any function disclosed herein; an apparatus may include a data storage device that stores code that when executed by a hardware processor or controller causes the hardware processor or controller to perform any method or portion of a method disclosed herein; an apparatus, method, system etc. may be as described in the detailed description; a non-transitory machine-readable medium may store instructions that when decoded and/or executed by a machine causes the machine to perform any method or portion of a method disclosed herein. Embodiments may include any details, features, etc, or combinations of details, features, etc. described in this specification.

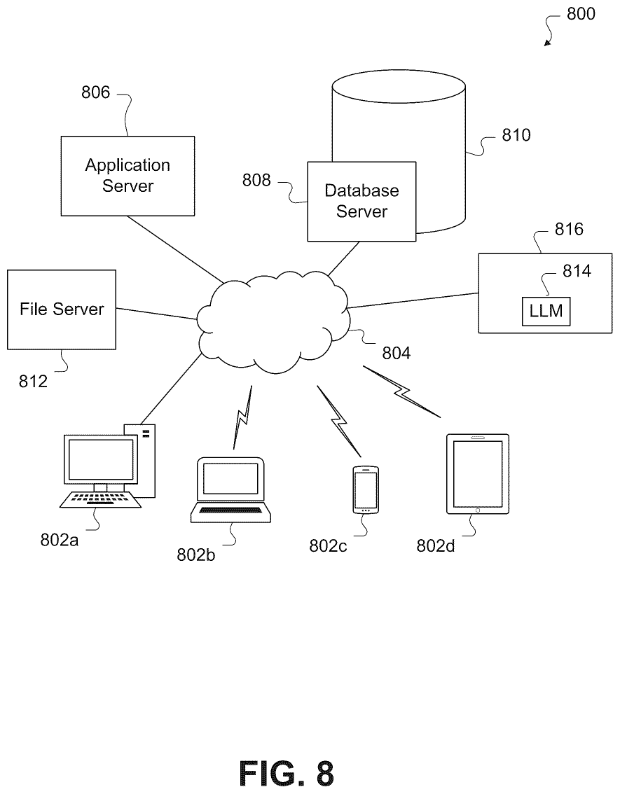

FIG. 8 illustrates an example system 800 to perform one or more operations according to this disclosure. As shown in FIG. 8, the system 800 includes one or more user devices 802a-802d, one or more networks 804, one or more application servers 806, and one or more database servers 808 associated with one or more databases 810 and/or one or more file servers 812. Each user device 802a-802d communicates over the network 804, such as via a wired or wireless connection. Each user device 802a-802d represents any suitable device or system used by at least one user to provide or receive information, such as a desktop computer, a laptop computer, a smartphone, and a tablet computer. However, any other or additional types of user devices may be used in the system 800. In some cases, the user devices 802a-802d may be used by users to perform machine learning operations such as those described herein.

The network 804 facilitates communication between various components of the system 800. For example, the network 804 may communicate Internet Protocol (IP) packets, frame relay frames, Asynchronous Transfer Mode (ATM) cells, or other suitable information between network addresses. The network 804 may include one or more local area networks (LANs), metropolitan area networks (MANs), wide area networks (WANs), all or a portion of a global network such as the Internet, or any other communication system or systems at one or more locations.

The application server 806 is coupled to the network 804 and is coupled to or otherwise communicates with the database server 808 and/or file server 812. The application server 806 supports operations for at least one machine learning-based platform or other platform using one or more large language models 814. The application server 806 may implement or otherwise include one or more applications to perform one or more operations described herein.

The database server 808 and/or the file server 812 operates to store and facilitate retrieval of various information used, generated, or collected by the application server 806 and the user devices 802a-802d. For example, the database server 808 and/or the file server 812 may store data associated with prompts to be used when querying the large language model 814 and information based on the queries to the large language model 814. Note that the database server 808 and/or the file server 812 may also be used within the application server 806 to store information, in which case the application server 806 may store the information itself. In some embodiments, the large language model 814 may be any suitable neural network, machine learning algorithm, model, and/or process, such as those described herein. For example, the large language model 814 includes or otherwise implements one or more linear regression models, logistic regression models, decision trees, random forests, support vector machines (SVM), k-nearest neighbors (KNN), convolutional neural networks (CNNs), recurrent neural networks (RNNs), long short-term memory networks (LSTMs), transformer networks, large language models (LLMs), autoencoders, generative adversarial networks (GANs), and/or variations thereof

In this example, the large language model 814 is shown as being implemented separate from the application server 806, such as when the large language model 814 is implemented on a server 816 that is separate from (and possibly remote from) the application server 806. Among other things, this may allow one organization to manage the platform implemented by the application(s) and another organization to manage the large language model 814. However, this is not necessarily required, and the large language model 814 may be implemented more local to the application server 806 and possibly on the application server 806 itself.

In some examples, various changes may be made to FIG. 8. For example, the system 800 may include any suitable number of user devices 802a-802d, networks 804, application servers 806, database servers 808, databases 810, file servers 812, large language models 814, and servers 816. Also, these components may be located in any suitable locations and might be distributed over a large area. In addition, while FIG. 8 illustrates one example operational environment in which one or more operations such as those described herein may be performed or otherwise implemented, this functionality may be used in any other suitable system. In an embodiment, each of the user devices 802a-802d, networks 804, application servers 806, database servers 808, databases 810, file servers 812, large language models 814, and/or servers 816 implement, perform, or are used to perform machine learning-based degradation optimization.

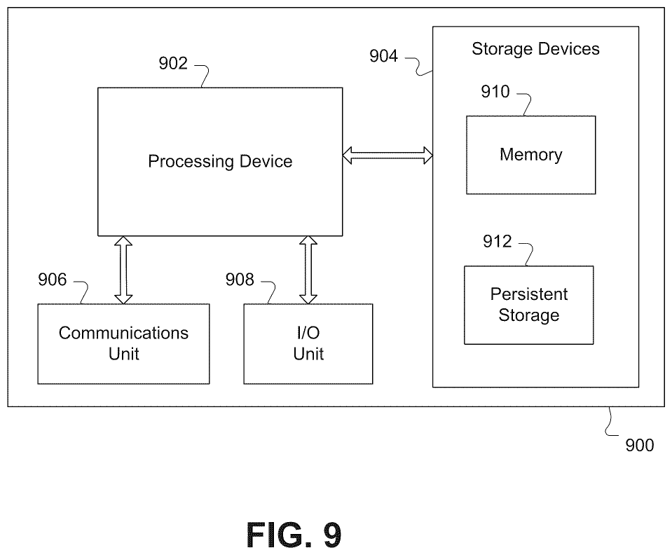

FIG. 9 illustrates an example device 900 supporting one or more operations described herein. For example, one or more instances of the device 900 may be used to at least partially implement the functionality of the application server 806 in the system 800 of FIG. 8. As other examples, one or more instances of the device 900 may be used to at least partially implement the functionality of each of the user devices 802a-802d, networks 804, application servers 806, database servers 808, databases 810, file servers 812, large language models 814, and servers 816 of FIG. 8. However, the functionality of the application server 806 or other components may be implemented in any other suitable manner.

As shown in FIG. 9, the device 900 denotes a computing device or system that includes at least one processing device 902, at least one storage device 904, at least one communications unit 906, and at least one input/output (I/O) unit 908. The processing device 902 may execute instructions that can be loaded into a memory 910. The processing device 902 includes any suitable number(s) and type(s) of processors or other processing devices in any suitable arrangement. Example types of processing devices 902 include one or more microprocessors, microcontrollers, reduced instruction set computers (RISCs), complex instruction set computers (CISCs), graphics processing units (GPUs), data processing units (DPUs), virtual processing units, associative process units (APUs), tensor processing units (TPUs), vision processing units (VPUs), neuromorphic chips, AI chips, quantum processing units (QPUs), cerebras wafer-scale engines (WSEs), digital signal processors (DSPs), application-specific integrated circuits (ASICs), field programmable gate arrays (FPGAs), or discrete circuitry.

The memory 910 and a persistent storage 912 are examples of storage devices 904, which represent any structure(s) capable of storing and facilitating retrieval of information (such as data, program code, and/or other suitable information on a temporary or permanent basis). The memory 910 may represent a random access memory or any other suitable volatile or non-volatile storage device(s). The persistent storage 912 may contain one or more components or devices supporting longer-term storage of data, such as a read only memory, hard drive, Flash memory, or optical disc.

The communications unit 906 supports communications with other systems or devices. For example, the communications unit 906 can include a network interface card or a wireless transceiver facilitating communications over at least one physical or wireless network, such as the network(s) 804. The communications unit 906 may support communications through any suitable physical or wireless communication link(s).

The I/O unit 908 allows for input and output of data. For example, the I/O unit 908 may provide a connection for user input through a keyboard, mouse, keypad, touchscreen, or other suitable input device. The I/O unit 908 may also send output to a display, printer, or other suitable output device. Note, however, that the I/O unit 908 may be omitted if the device 900 does not require local I/O, such as when the device 900 represents a server or other device that can be accessed remotely.

In some embodiments, the instructions executed by the processing device 902 include instructions that implement the functionality of one or more operations such as those described herein. Thus, for example, the instructions when executed by the processing device 902 may cause the device 900 to perform one or more operations such as those described herein. The instructions when executed by the processing device 902 may also cause the device 900 to receive responses from the large language model 814 and generate information based on the responses from the large language model 814.

Although FIG. 9 illustrates one example of a device 900 supporting one or more operations such as those described herein, various changes may be made to FIG. 9. For example, computing and communication devices and systems come in a wide variety of configurations, and FIG. 9 does not limit this disclosure to any particular computing or communication device or system. In some examples, the device 900 implements, performs, or is used to perform machine learning-based degradation optimization.

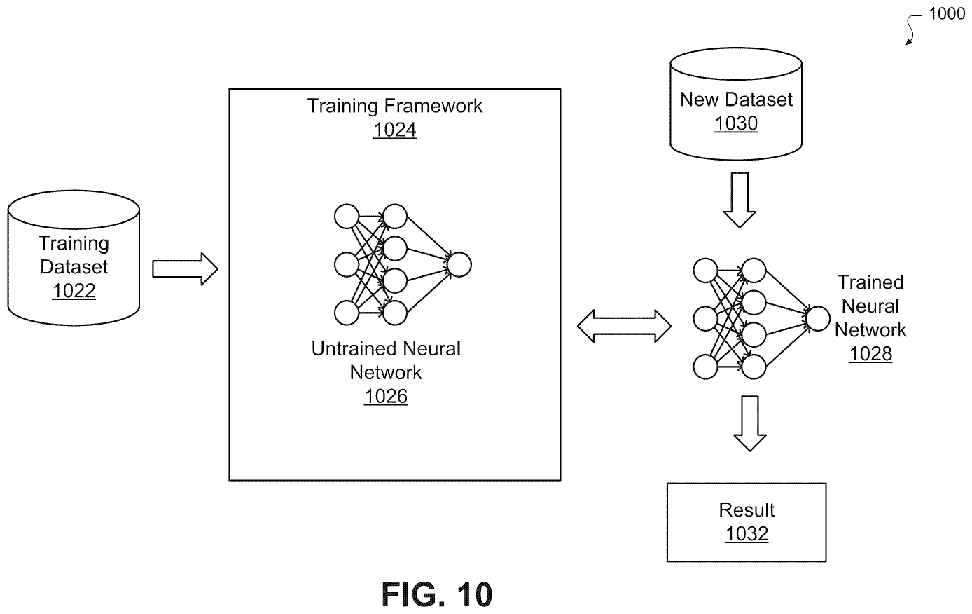

FIG. 10 illustrates training and deployment of a deep neural network supporting one or more operations described herein. An untrained neural network 1026 can be trained using a training dataset 1022. Training framework 1024 can be a PyTorch framework, and/or a training framework 1004 can include a TensorFlow, Boost, Caffe, Microsoft Cognitive Toolkit/CNTK, MXNet, Chainer, Keras, Deeplearning4j, or other training framework. Training framework 1024 can train an untrained neural network 1026 and enables it to be trained using processing resources described herein to generate a trained neural network 1028. Weights may be chosen randomly or by pre-training using a deep belief network. Training may be performed in either a supervised, partially supervised, or unsupervised manner. Training framework 1024 may be implemented using the device 900 of FIG. 9. In some embodiments, untrained neural network 1026 and/or trained neural network 1028 may be the large language model 814 of FIG. 8.

Untrained neural network 1026 can be trained using supervised learning, wherein training dataset 1022 includes an input paired with a desired output for an input, or where training dataset 1022 includes input having a known output and an output of neural network 1026 is manually graded. Untrained neural network 1026 can be trained in a supervised manner and processes inputs from training dataset 1022 and compares resulting outputs against a set of expected or desired outputs. Errors can then be propagated back through untrained neural network 1026. Training framework 1024 can adjust weights that control untrained neural network 1026. Training framework 1024 can include tools to monitor how well untrained neural network 1026 is converging towards a model, such as, but not limited to, trained neural network 1028, suitable to generating correct answers, such as, but not limited to, in result 1032, based on input data such as, but not limited to, a new dataset 1030. Training framework 1024 can train untrained neural network 1026 repeatedly while adjusting weights to refine an output of untrained neural network 1026 using a loss function and adjustment algorithm, such as, but not limited to, stochastic gradient descent. Training framework 1024 can train untrained neural network 1026 until untrained neural network 1026 achieves a desired accuracy. Trained neural network 1028 can then be deployed to implement any number of machine learning operations.

Untrained neural network 1026 can be trained using unsupervised learning, wherein untrained neural network 1026 attempts to train itself using unlabeled data. Unsupervised learning training dataset 1022 can include input data without any associated output data or “ground truth” data. Untrained neural network 1026 can learn groupings within training dataset 1022 and can determine how individual inputs may be related to untrained dataset 1022. Unsupervised training can be used to generate a self-organizing map in trained neural network 1028 capable of performing operations useful in reducing dimensionality of new dataset 1030. Unsupervised training can also be used to perform anomaly detection, which allows identification of data points in new dataset 1030 that deviate from normal patterns of new dataset 1030. In an embodiment, the untrained neural network 1026 and/or trained neural network 1028 can be any suitable neural networks, machine learning algorithms, models, and/or variations thereof, which can use any suitable techniques and/or processes, such as linear regression models, logistic regression models, decision trees, random forests, support vector machines (SVM), k-nearest neighbors (KNN), convolutional neural networks (CNNs), recurrent neural networks (RNNs), long short-term memory networks (LSTMs), transformer networks, large language models (LLMs), autoencoders, generative adversarial networks (GANs), and/or variations thereof.

Semi-supervised learning may be used, which is a technique in which in training dataset 1022 includes a mix of labeled and unlabeled data. Training framework 1024 may be used to perform incremental learning, such as, but not limited to, through transferred learning techniques. Incremental learning can enable trained neural network 1028 to adapt to new dataset 1030 without forgetting knowledge instilled within trained neural network 1028 during initial training. The trained neural networks 1028 may be utilized to perform one or more operations such as those described herein. In at least one embodiment, the training framework 1024 and/or the trained neural network 1028 implement, perform, or are used to perform machine learning-based degradation optimization.

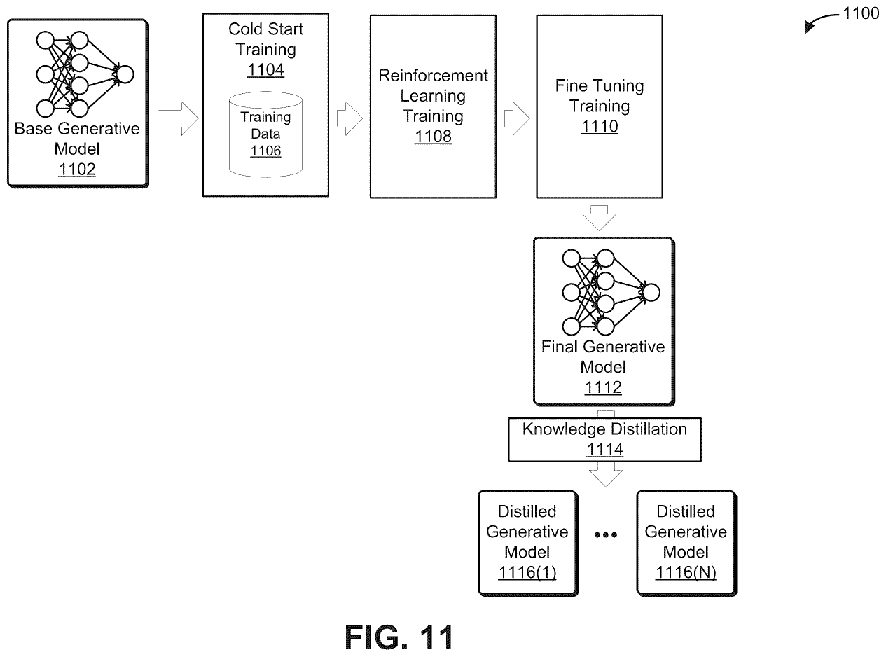

FIG. 11 illustrates an example training process 1100 of a generative model, according to at least one embodiment. In at least one embodiment, a base generative model 1102 is trained at least through a cold start training 1104, a reinforcement learning training 1108, and/or a fine tuning training 1110 to result in a final generative model 1112. The final generative model 1112 may be processed by a knowledge distillation process 1114 to generate distilled generative models 1116(1)-1116(N). The base generative model 1102, the final generative model 1112, and/or the distilled generative models 1116(1)-1116(N) may be the large language model 814 of FIG. 8. In at least one embodiment, one or more operations of the training process 1100 are implemented by or otherwise performed using one or more components of the system 800 of FIG. 8, device 900 of FIG. 9, and/or any suitable combination of hardware and/or software such as described herein. In some examples, one or more operations of the training process 1100 are implemented by or otherwise performed in connection with the training framework 1024 of FIG. 10.

The base generative model 1102 may be any suitable neural network model, such as a transformer-based model (e.g., generative pre-trained transformer (GPT)), variational autoencoder (VAE), generative adversarial network (GAN), diffusion model, mixture of experts (MoE) model, autoregressive model, and/or any suitable model that may be utilized to generate outputs, such as within the context of natural language processing (NLP), image generation, and/or variations thereof. The base generative model 1102 may be trained using the cold start training 1104, which may comprise one or more processes of updating the base generative model 1102 using the training data 1106. The training data 1106 may be any suitable training data for a generative model, such as samples of text, images, video, and/or the like. The training data 1106 may include labeled training data, which may refer to data with annotations such as tags, categories, classifications, or other information related to the data that may guide training of a generative model. The training data 1106 may include text inputs paired with desired text outputs, such as, for example, a generative language model prompt and a desired or ground truth response to be generated by a generative model in response to the prompt.

In at least one embodiment, the base generative model 1102 is trained through the cold start training 1104, which involves causing the base generative model 1102 to generate outputs based on data of training data 1106, comparing the outputs to ground truth data (e.g., desired outputs), and updating the base generative model 1102 using one or more loss functions. The cold start training 1104 may include processes of iteratively adjusting the base generative model 1102's parameters using forward propagation to compute predictions, a loss function (e.g., cross-entropy) to measure prediction errors, and backpropagation with optimization algorithms (e.g., Adam) to minimize the loss. The cold start training 1104 may be performed for a pre-defined number of iterations, until one or more particular loss values are achieved, and/or based on any suitable metric or event.

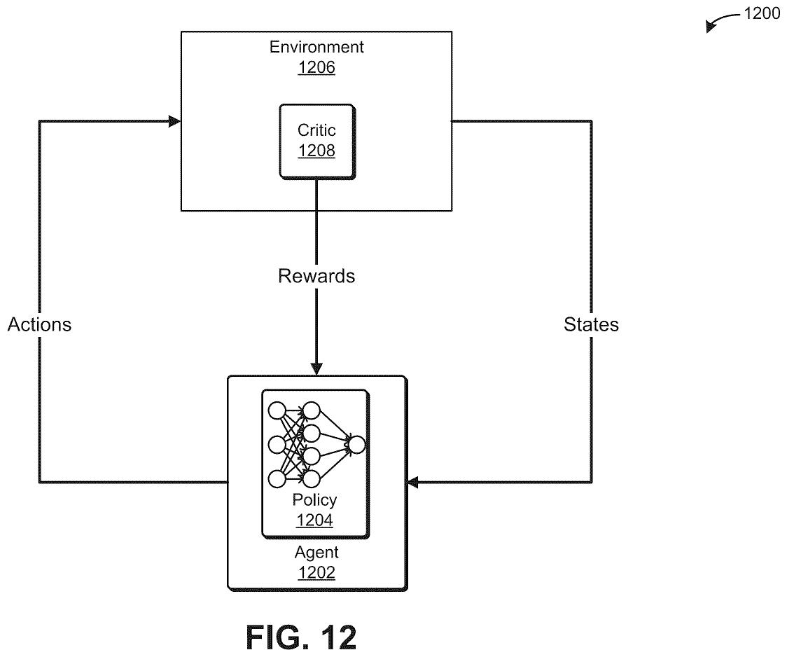

In at least one embodiment, the base generative model 1102 is trained through the reinforcement learning training 1108. The reinforcement learning training 1108 may include processes of training a model to generate correct outputs by causing the model to interact with an environment/inputs and receive feedback in the form of rewards or penalties. In some embodiments, the reinforcement learning training 1108 may include processes that do not require labeled data, such as group relative policy optimization (GRPO) and/or proximal policy optimization (PPO), in which pre-defined reward functions are used to process outputs and provide updates to the model. As an illustrative example, the base generative model 1102 may be trained using reinforcement learning training 1108 by at least causing the base generative model 1102 to process one or more prompts to generate candidate responses, scoring the candidate responses using pre-defined reward functions (e.g., based on answer correctness, code execution, logical structure, and/or any suitable metric), grouping responses based on tasks, and/or updating the base generative model 1102 to maximize the likelihood of higher ranked responses. Further information regarding reinforcement learning training can be found in the description of FIG. 12.

In at least one embodiment, the base generative model 1102 is trained through the fine tuning training 1110, such as after undergoing one or more training processes of the cold start training 1104 and/or the reinforcement learning training 1108. The fine tuning training 1110 may include training processes of using labeled and/or unlabeled training data to further train the base generative model 1102, such as training data specific to one or more NLP tasks, image processing tasks, and/or variations thereof. In some examples, outputs generated by the base generative model 1102, such as part of the reinforcement learning training 1108, are used as training data in the fine tuning training 1110. The fine tuning training 1110 may include reinforcement learning training processes, supervised and/or semi-supervised training processes, and/or any suitable training processes such as those described herein. The fine tuning training 1110 may include additional reinforcement learning training processes using reward functions specific to particular contexts in which the base generative model 1102 may be used, such as specific reward functions to indicate language correctness or specific reasoning patterns or logic, and/or any suitable reward functions pertaining to any suitable context or task. The fine tuning training 1110 applied to the base generative model 1102, which may be trained using the cold start training 1104 and/or the reinforcement learning training 1108, may result in the final generative model 1112, which may be used or otherwise deployed in connection with one or more systems described herein to perform one or more operations.

In at least one embodiment, the final generative model 1112 may be processed through knowledge distillation 1114 to generate distilled generative models 1116(1)-1116(N). In an embodiment, the knowledge distillation 1114 includes processes of transferring knowledge from a large, complex model (e.g., the final generative model 1112) to a smaller, more efficient model (e.g., the distilled generative models 1116(1)-1116(N)) while preserving the generative capabilities of the original model, which may involve training the smaller models to mimic the outputs of the large model by minimizing a loss function that measures the difference between their predictions. In generative models, this process may include matching the probability distributions over generated tokens, images, or other outputs, as well as aligning intermediate representations learned by the large model. In some examples, the distilled generative models 1116(1)-1116(N) may be referred to as student models and may be trained or otherwise generated to retain or mimic the generative capabilities of the final generative model 1112. The distilled generative models 1116(1)-1116(N) may be used or otherwise deployed in connection with one or more systems described herein to perform one or more operations. In at least one embodiment, the final generative model 1112 and/or the distilled generative models 1116(1)-1116(N) implement, perform, or are used to perform machine learning-based degradation optimization.

FIG. 12 illustrates an example 1200 of reinforcement learning, according to at least one embodiment. In an embodiment, a policy 1204 may be trained using rewards generated by a critic 1208 based on actions generated by an agent 1202 from states of an environment 1206. The policy 1204 may be a machine learning model such as the large language model 814 of FIG. 8 and/or other generative models such as those described herein. The agent 1202 and/or the critic 1208 may be collections of hardware and/or software that may perform reinforcement learning operations such as those described herein. The agent 1202 may be implemented as a software program that may encode or otherwise utilize the policy 1204. In at least one embodiment, the agent 1202 and/or the critic 1208 implement, perform, or are used to perform machine learning-based degradation optimization.

In an embodiment, the agent 1202 interacts with the environment 1206 to learn or otherwise update the policy 1204, which may be a generative model such as those described herein that maps states to actions. The agent 1202 may generate actions based on the policy 1204, in which the critic 1208 may evaluate the agent 1202's actions to generate rewards indicating the quality of the actions. The agent 1202 may use this feedback to iteratively update the policy 1204, such as through optimization techniques like gradient descent and/or variations thereof. The agent 1202 may be used as part of reinforcement learning algorithms such as PPO, balance exploration (e.g., trying new actions to discover better strategies) and exploitation (e.g., refining known strategies to maximize rewards). The policy 1204 may then be deployed or utilized by one or more systems to perform operations such as those described herein.

The agent 1202 may be utilized to perform one or more policy optimization processes to train the policy 1204. The agent 1202 may receive states from the environment 1206, which may refer to any suitable input data associated with a context that the policy 1204 is to be used. As an illustrative example, the policy 1204 may be a generative model, in which the environment 1206 may include a collection of data from which the policy 1204 may generate outputs, such as input text, images, and/or variations thereof. The agent 1202 may be provided with prompts and may be caused to generate responses, which may include text, images, and/or any suitable content. The responses (e.g., “Actions”) may be provided to the critic 1208, which may encode various functions and/or models that may calculate a reward for a given response. The critic 1208 may apply one or more functions to evaluate the quality of each response, and provide the agent 1202 with one or more rewards that indicate the quality of the responses. The agent 1202 may utilize the rewards to update the policy 1204 to maximize high-reward responses, such as by modifying one or more parameters of the policy 1204 using one or more functions based on the rewards provided by the critic 1208.

In some examples, the agent 1202 and/or the critic 1208 may perform one or more policy optimization (e.g., GRPO, PPO) processes, in which, for a given prompt, the agent 1202 uses the policy 1204 to generate one or more responses. The critic 1208 may apply a reward model to evaluate the quality of each response and the responses may be grouped and compared to the group's average reward to determine which are better or worse. The policy 1204 may be adjusted to favor high-reward responses while avoiding drastic changes, such as by using a KL divergence constraint, and the process may repeat iteratively until particular response quality is achieved. In some embodiments, reward engineering processes may be performed to optimize rewards generated by the critic 1208, such as by generating or selecting a reward function that guides the policy 1204's generation process to produce outputs aligned with specific objectives or preferences. The reward function may quantify the quality of generated content, providing feedback that incentivizes desirable behaviors, such as coherence, relevance, creativity, or adherence to ethical guidelines, while penalizing undesirable outputs like factual inaccuracies or offensive content. The rewards generated by the critic 1208 may be modified or otherwise engineered in a manner to train the policy 1204 to generate outputs aligned with specific contexts and/or use cases, such as those described herein.

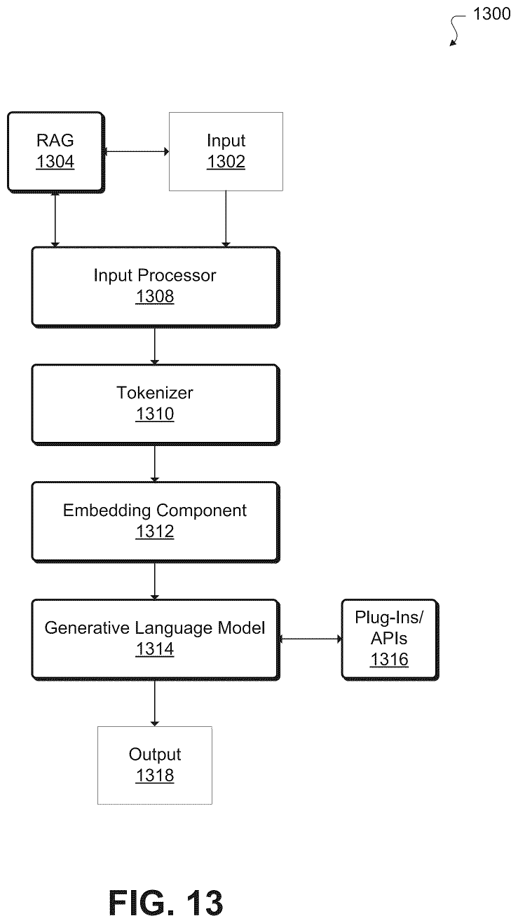

FIG. 13 is a block diagram of an example generative language model system 1300 suitable for use in implementing at least some embodiments of the present disclosure. In the example illustrated in FIG. 13, the generative language model system 1300 includes a retrieval augmented generation (RAG) component 1304, an input processor 1308, a tokenizer 1310, an embedding component 1312, plug-ins/APIs 1316, and a generative language model (LM) 1314 (which may include generative machine learning models, language models, large language models (LLMs), vision language models (VLMs), multi-modal language models (MMLMs), etc.), and/or other types of machine learning models). The generative LM 1314 may be the large language model 814 of FIG. 8 and/or untrained neural network 1026 and/or trained neural network 1028 of FIG. 10.

The input processor 1308 may receive an input 1302 comprising text and/or other types of input data (e.g., audio data, video data, image data, sensor data (e.g., LiDAR, RADAR, ultrasonic, etc.), 3D design data, CAD data, universal scene descriptor (USD) data, and/or variations thereof. In some embodiments, the input 1302 includes plain text in the form of one or more sentences, paragraphs, and/or documents. Additionally or alternatively, the input 1302 may include numerical sequences, precomputed embeddings (e.g., word or sentence embeddings), and/or structured data (e.g., in tabular formats, JSON, or XML). In some implementations in which the generative LM 1314 is capable of processing multi-modal inputs, the input 1302 may combine text (or may omit text) with image data, audio data, video data, design data, USD data, and/or other types of input data, such as but not limited to those described herein. Taking raw input text as an example, the input processor 1308 may prepare raw input text in various ways. For example, the input processor 1308 may perform various types of text filtering to remove noise (e.g., special characters, punctuation, HTML tags, stopwords, portions of an image(s), portions of audio, etc.) from relevant textual content. The input processor 1308 may apply text normalization, for example, by converting all characters to lowercase, removing accents, and/or handling special cases like contractions or abbreviations to ensure consistency. These are just a few examples, and other types of input processing may be applied.

In some embodiments, a RAG component 1304 (which may include one or more RAG models, and/or may be performed using the generative LM 1314 itself) may be used to retrieve additional information to be used as part of the input 1302 or prompt. RAG may be used to enhance the input to the LLM/VLM/MMLM/etc. with external knowledge, so that answers to specific questions or queries or requests are more relevant-such as in a case where specific knowledge is required. The RAG component 1304 may fetch this additional information from one or more external sources, which can be used along with the prompt to improve accuracy of the responses or outputs of the model.

For example, in some embodiments, the input 1302 may be generated using the query or input to the model (e.g., a question, a request, etc.) in addition to data retrieved using the RAG component 1304. In some embodiments, the input processor 1308 may analyze the input 1302 and communicate with the RAG component 1304 (or the RAG component 1304 may be part of the input processor 1308, in embodiments) in order to identify relevant text and/or other data to provide to the generative LM 1314 as additional context or sources of information from which to identify the response, answer, or output 1318, generally. For example, where the input indicates that the user is interested in a desired tire pressure for a particular make and model of vehicle, the RAG component 1304 may retrieve—using a RAG model performing a vector search in an embedding space, for example—the tire pressure information or the text corresponding thereto from a digital (embedded) version of the user manual for that particular vehicle make and model.

The RAG component 1304 may use various RAG techniques. For example, naïve RAG may be used where documents are indexed, chunked, and applied to an embedding model to generate embeddings corresponding to the chunks. A user query may also be applied to the embedding model and/or another embedding model of the RAG component 1304 and the embeddings of the chunks along with the embeddings of the query may be compared to identify the most similar/related embeddings to the query, which may be supplied to the generative LM 1314 to generate an output. As another example, prior to passing chunks to the embedding model, the chunks may undergo pre-retrieval processes (e.g., routing, rewriting, metadata analysis, expansion, etc.). In addition, prior to generating the final embeddings, post-retrieval processes (e.g., re-ranking, prompt compression, etc.) may be performed on the outputs of the embedding model prior to final embeddings being used as comparison to an input query.

As another example, the RAG component 1304 may utilize knowledge graphs as a source of context or factual information. The RAG component 1304 may be implemented using a graph database as a source of contextual information sent to the LLM/VLM/MMLM/etc. When implementing graph RAG, the systems and methods described herein use a graph as a content store and extract relevant chunks of documents and ask the LLM/VLM/MMLM/etc. to answer using them. The knowledge graph, in such embodiments, may contain relevant textual content and metadata about the knowledge graph as well as be integrated with a vector database. In some embodiments, the graph RAG may use a graph as a subject matter expert, where descriptions of concepts and entities relevant to a query/prompt may be extracted and passed to the model as semantic context. These descriptions may include relationships between the concepts. In other examples, the graph may be used as a database, where part of a query/prompt may be mapped to a graph query, the graph query may be executed, and the LLM/VLM/MMLM/etc. may summarize the results. In such an example, the graph may store relevant factual information, and a query (natural language query) to graph query tool (NL-to-Graph-query tool) and entity linking may be used.

In some embodiments, graph RAG (e.g., using a graph database) may be combined with standard (e.g., vector database) RAG, and/or other RAG types, to benefit from multiple approaches. In any embodiments, the RAG component 1304 may implement a plugin, API, user interface, and/or other functionality to perform RAG. For example, a plug-in may be used by the LLM/VLM/MMLM/etc. to run queries against the knowledge graph to extract relevant information for feeding to the model, and a standard or vector RAG plug-in may be used to run queries against a vector database. For example, the graph database may interact with a plug-in's REST interface such that the graph database is decoupled from the vector database and/or the embeddings models.

The tokenizer 1310 may segment the (e.g., processed) text data into smaller units (tokens) for subsequent analysis and processing. The tokens may represent individual words, subwords, characters, portions of audio/video/image/etc., depending on the implementation. Word-based tokenization divides the text into individual words, treating each word as a separate token. Subword tokenization breaks down words into smaller meaningful units (e.g., prefixes, suffixes, stems), enabling the generative LM 1314 to understand morphological variations and handle out-of-vocabulary words more effectively. Character-based tokenization represents each character as a separate token, enabling the generative LM 1314 to process text at a fine-grained level. The choice of tokenization strategy may depend on factors such as the language being processed, the task at hand, and/or characteristics of the training dataset. As such, the tokenizer 1310 may convert the (e.g., processed) text into a structured format according to tokenization schema being implemented in the particular embodiment.

The embedding component 1312 may use any known embedding technique to transform discrete tokens into (e.g., dense, continuous vector) representations of semantic meaning. For example, the embedding component 1312 may use pre-trained word embeddings (e.g., Word2Vec, GloVe, or FastText), one-hot encoding, Term Frequency-Inverse Document Frequency (TF-IDF) encoding, one or more embedding layers of a neural network, and/or otherwise.

The generative LM 1314 and/or other components of the generative LM system 1300 may be used to perform one or more operations such as those described herein. For example, transformer-based architectures such as those used in models like GPT may be implemented, and may include self-attention mechanisms that weigh the importance of different words or tokens in the input sequence and/or feedforward networks that process the output of the self-attention layers, applying non-linear transformations to the input representations and extracting higher-level features. Some non-limiting example architectures include transformers (e.g., encoder-decoder, decoder only, multi-modal), RNNs, LSTMs, fusion models, diffusion models, cross-modal embedding models that learn joint embedding spaces, graph neural networks (GNNs), hybrid architectures combining different types of architectures adversarial networks like generative adversarial networks or GANs or adversarial autoencoders (AAEs) for joint distribution learning, and others. As such, depending on the implementation and architecture, the embedding component 1312 may apply an encoded representation of the input 1302 to the generative LM 1314, and the generative LM 1314 may process the encoded representation of the input 1302 to generate an output 1318, which may include responsive text and/or other types of data.

As described herein, in some embodiments, the generative LM 1314 may be configured to access or use—or capable of accessing or using—plug-ins/APIs 1316 (which may include one or more plug-ins, application programming interfaces (APIs), databases, data stores, repositories, etc.). For example, for certain tasks or operations that the generative LM 1314 is not ideally suited for, the model may have instructions (e.g., as a result of training, and/or based on instructions in a given prompt, such as those retrieved using the RAG component 1304) to access one or more plug-ins/APIs 1316 (e.g., 3rd party plugins) for help in processing the current input. In such an example, where at least part of a prompt is related to restaurants or weather, the model may access one or more restaurant or weather plug-ins (e.g., via one or more APIs), send at least a portion of the prompt related to the particular plug-in/API 1316 to the plug-in/API 1316, the plug-in/API 1316 may process the information and return an answer to the generative LM 1314, and the generative LM 1314 may use the response to generate the output 1318. This process may be repeated—e.g., recursively—for any number of iterations and using any number of plug-ins/APIs 1316 until an output 1318 that addresses each ask/question/request/process/operation/etc. from the input 1302 can be generated. As such, the model(s) may not only rely on its own knowledge from training on a large dataset(s) and/or from data retrieved using the RAG component 1304, but also on the expertise or optimized nature of one or more external resources—such as the plug-ins/APIs 1316. Additionally, one or more components of the generative language model system 1300 may implement, perform, or are used to perform machine learning-based degradation optimization.

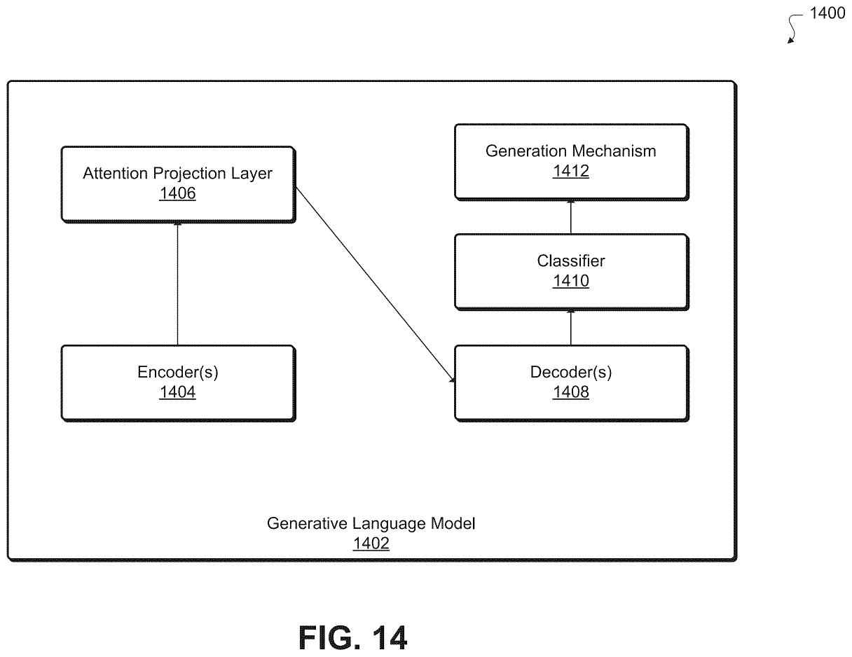

FIG. 14 is a block diagram of an example implementation in which the generative language model (LM) 1402 includes a transformer encoder-decoder, which can be used to perform one or more operations described herein. The generative LM 1402 may be used to perform or otherwise implement one or more operations such as those described herein. In some embodiments, input text is tokenized into tokens such as words, and each token is encoded into a corresponding embedding. Since these token embeddings typically do not represent the position of the token in the input sequence, any known technique may be used to add a positional encoding to each token embedding to encode the sequential relationships and context of the tokens in the input sequence. As such, the (e.g., resulting) embeddings may be applied to one or more encoder(s) 1404 of the generative LM 1402. The generative LM 1402 may be the generative LM 1314 of FIG. 13.

In an example implementation, the encoder(s) 1404 forms an encoder stack, where each encoder includes a self-attention layer and a feedforward network. In an example transformer architecture, each token (e.g., word) flows through a separate path. As such, each encoder may accept a sequence of vectors, passing each vector through the self-attention layer, then the feedforward network, and then upwards to the next encoder in the stack. Any known self-attention technique may be used. For example, to calculate a self-attention score for each token (word), a query vector, a key vector, and a value vector may be created for each token, a self-attention score may be calculated for pairs of tokens by taking the dot product of the query vector with the corresponding key vectors, normalizing the resulting scores, multiplying by corresponding value vectors, and summing weighted value vectors. The encoder may apply multi-headed attention in which the attention mechanism is applied multiple times in parallel with different learned weight matrices. Any number of encoders may be cascaded to generate a context vector encoding the input. An attention projection layer 1406 may convert the context vector into attention vectors (keys and values) for the decoder(s) 1408. In some embodiments, the encoder(s) 1404 (e.g., and/or other encoders described herein) is referred to as an autoencoder, and may generate latent space or compressed representations of data (e.g., training data, input data, and/or variations thereof) and/or decoded or decompressed representations of the data, such as through one or more processes described herein.

In an example implementation, the decoder(s) 1408 form a decoder stack, where each decoder includes a self-attention layer, an encoder-decoder self-attention layer that uses the attention vectors (keys and values) from the encoder to focus on relevant parts of the input sequence, and a feedforward network. As with the encoder(s) 1404, in an example transformer architecture, each token (e.g., word) flows through a separate path in the decoder(s) 1408. During a first pass, the decoder(s) 1408, a classifier 1410, and a generation mechanism 1412 may generate a first token, and the generation mechanism 1412 may apply the generated token as an input during a second pass. The process may repeat in a loop, successively generating and adding tokens (e.g., words) to the output from the preceding pass and applying the token embeddings of the composite sequence with positional encodings as an input to the decoder(s) 1408 during a subsequent pass, sequentially generating one token at a time (known as auto-regression) until predicting a symbol or token that represents the end of the response. Within each decoder, the self-attention layer is typically constrained to attend only to preceding positions in the output sequence by applying a masking technique (e.g., setting future positions to negative infinity) before the softmax operation. In an example implementation, the encoder-decoder attention layer operates similarly to the (e.g., multi-headed) self-attention in the encoder(s) 1404, except that it creates its queries from the layer below it and takes the keys and values (e.g., matrix) from the output of the encoder(s) 1404.

As such, the decoder(s) 1408 may output some decoded (e.g., vector) representation of the input being applied during a particular pass. The classifier 1410 may include a multi-class classifier comprising one or more neural network layers that project the decoded (e.g., vector) representation into a corresponding dimensionality (e.g., one dimension for each supported word or token in the output vocabulary) and a softmax operation that converts logits to probabilities. As such, the generation mechanism 1412 may select or sample a word or token based on a corresponding predicted probability (e.g., select the word with the highest predicted probability) and append it to the output from a previous pass, generating each word or token sequentially. The generation mechanism 1412 may repeat the process, triggering successive decoder inputs and corresponding predictions until selecting or sampling a symbol or token that represents the end of the response, at which point, the generation mechanism 1412 may output the generated response. In at least one embodiment, the generative language model 1402 may implement, perform, or be used to perform machine learning-based degradation optimization.

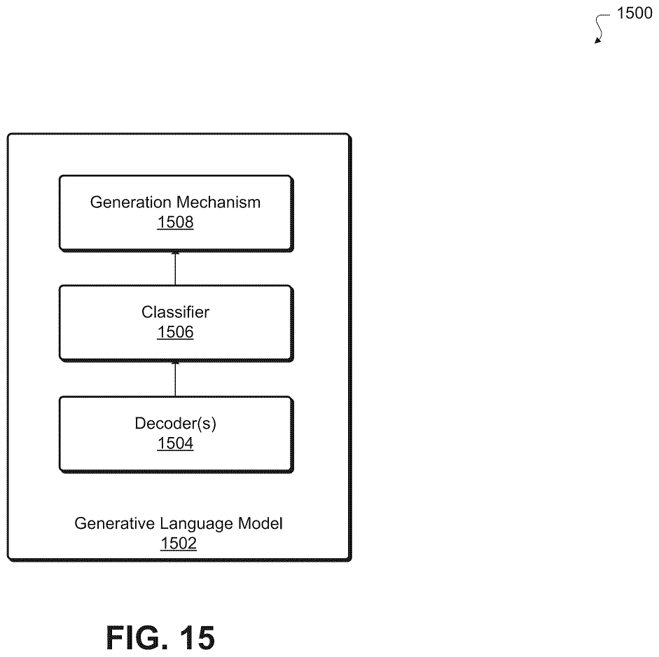

FIG. 15 is a block diagram of an example implementation in which the generative language model (LM) 1502 includes a decoder-only transformer architecture to perform one or more operations described herein. The generative LM 1502 may be the generative LM 1314 of FIG. 13. The generative LM 1502 may be used to perform or otherwise implement one or more operations such as those described herein. In some examples, the decoder(s) 1504 of FIG. 15 may operate similarly as one or more decoders described herein except each of the decoder(s) 1504 of FIG. 15 omits the encoder-decoder self-attention layer (since there is no encoder in this implementation). As such, the decoder(s) 1504 may form a decoder stack, where each decoder includes a self-attention layer and a feedforward network. Furthermore, instead of encoding the input sequence, a symbol or token representing the end of the input sequence (or the beginning of the output sequence) may be appended to the input sequence, and the resulting sequence (e.g., corresponding embeddings with positional encodings) may be applied to the decoder(s) 1504. Each token (e.g., word) may flow through a separate path in the decoder(s) 1504, and the decoder(s) 1504, a classifier 1506, and a generation mechanism 1508 may use auto-regression to sequentially generate one token at a time until predicting a symbol or token that represents the end of the response. The classifier 1506 and the generation mechanism 1508 may operate similarly as those described herein, with the generation mechanism 1508 selecting or sampling each successive output token based on a corresponding predicted probability and appending it to the output from a previous pass, generating each token sequentially until selecting or sampling a symbol or token that represents the end of the response. These and other architectures described herein are meant simply as examples, and other suitable architectures may be implemented within the scope of the present disclosure. In at least one embodiment, the generative language model 1502 may implement, perform, or be used to perform machine learning-based degradation optimization.

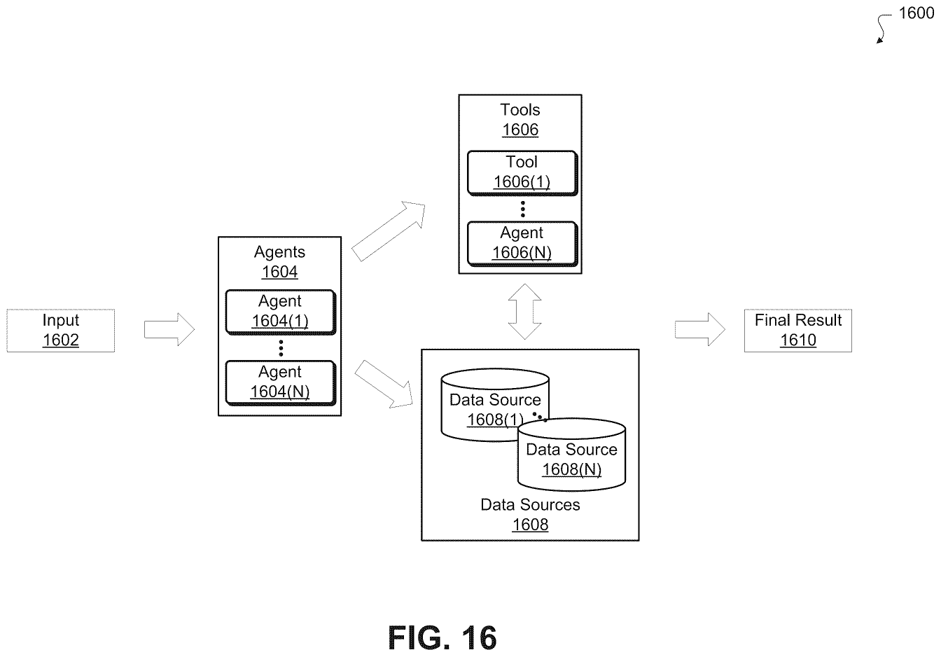

FIG. 16 depicts a diagram 1600 of an example agentic system, according to at least one embodiment. As shown, an initial input 1602 is received by the system from either a user (e.g., a natural language input) or another system (e.g., a machine-readable input) and processed using one or more of agents 1604, tools 1606, and/or data sources 1608 to generate a final result 1610. The system may include at least one or more of the agents 1604, tools 1606, and/or data sources 1608 and may be implemented using any suitable collection of hardware and/or software computing resources to perform operations described herein. In some examples, one or more components of the system are implemented using the system 800 of FIG. 8 and/or the device 900 of FIG. 9.

The system may include software, which may be referred to as an orchestrator, that supervises, controls, and/or otherwise administrates many different agents 1604 and tools 1606. The system can utilize one or even several machine learning models and can execute supervisory functions, such as routing inputs to specific agents to accomplish a set of prescribed tasks (e.g., retrieval requests prescribed by the system to answer a query). Machine learning models can include some or all of the different types of models described herein (e.g., multimodal machine learning models, LLMs, data models, statistical models, audio models, visual models, audiovisual models, etc.). Agents 1604 can include one or even several multimodal models (e.g., LLMs) to accomplish tasks using a variety of different tools. Different agents can use tools available to them to execute and process unstructured data retrieval requests, structured data retrieval requests, API calls (e.g., for accessing artificial intelligence application insights), and the like. Tools 1606 can include specific functions and/or machine learning models to accomplish a given task (or set of tasks). The system may also be associated with or otherwise have access to data sources 1608, which be one or more databases, data sources, and/or any suitable data source, stream, or database. The data sources 1608 may include databases associated with one or more clients, client applications, systems, and/or variations thereof, and may include data such as data associated with client production, client resource usage, client analytics, and/or any suitable data.

Agents 1604 can adapt to perform differently based on contexts. A context may relate to a particular domain (e.g., industry) and an agent may employ a particular model (e.g., large language model, other machine learning model, and/or data model) that has been trained on industry-specific datasets, such as healthcare datasets. The particular agent can use a healthcare model when receiving inputs associated with a healthcare environment and can also easily and efficiently adapt to use a different model based on different inputs or context. Indeed, some or all of the models described herein may be trained for specific domains in addition to, or instead of, more general purposes. The agentic system may leverage domain specific models to produce accurate context specific retrieval and insights.

The system manages the agents 1604 to efficiently process disparate inputs or different portions of an input. For example, an input may require the system to access and retrieve data sources 1608 such as disparate data sources (e.g., unstructured datastores, structured datastores, timeseries datastores, and the like), database tables from different types of databases, and machine learning insights from different machine learning applications. The different agents can each separately, and in parallel, handle each of these requests, greatly increasing computational efficiency.

Agents 1604 can process the disparate data returned by the different agents and/or tools. For example, LLMs typically receive inputs in natural language format. The agents may receive information in a non-natural language format (e.g., database table, image, audio) from a tool and transform it into natural language describing the tool output in a format understood by LLMs. A given LLM can then process that input to “answer,” or otherwise satisfy the initial input. While LLM is used for the purpose of illustration, the embodiments discussed and variations of those embodiments can utilize different neural networks, machine learning models, or other AI models.

The system may obtain an input 1602, which may be a prompt or other input data provided by one or more users. The system may process the input 1602, such as through acronym handling, translation handling, punctuation handling, input identification (e.g., identifying different portions of the input 1602 for processing by different agents). The system can use a multimodal model (e.g., large language model, such as the generative LM 1314 of FIG. 13) to further process the input 1602 to create a plan for determining a final result 1610 for the input. The plan may include a prescribed set of tasks, such as structured data retrieval tasks, unstructured data retrieval tasks, timeseries processing tasks, visualization tasks, and the like. In some embodiments, the plan can designate which tools 1606 should be used to execute the tasks, and the system can select the agents 1604 based on the designated tools. In some embodiments, the plan can designate which agents of agents 1604 should be used to execute the tasks, and the agents can independently designate which tools of tools 1606 should be used to execute the tasks.

The system may provide the input 1602 to the agents 1604 for further processing. The system may use one or more multimodal models (e.g., language, video, audio, statistical models, etc.), and/or other machine learning models, to interpret the input 1602 to select appropriate agents 1604 and appropriate tools 1606. For example, the system may determine that a first portion of the input requires a database query, while another portion of the input requires an API call. The system can appropriately route the first portion of the input to an appropriate agent of agents 1604 (e.g., a structured data retrieval agent) and route the second portion of the input to another agent (e.g., API agent). There could be any number of such agents 1604 accessing any number of different tools 1606. The system may also instruct the agents 1604 to operate in parallel and/or serially. The agents 1604 and/or tools 1606 may be implemented using the device 900 of FIG. 9.

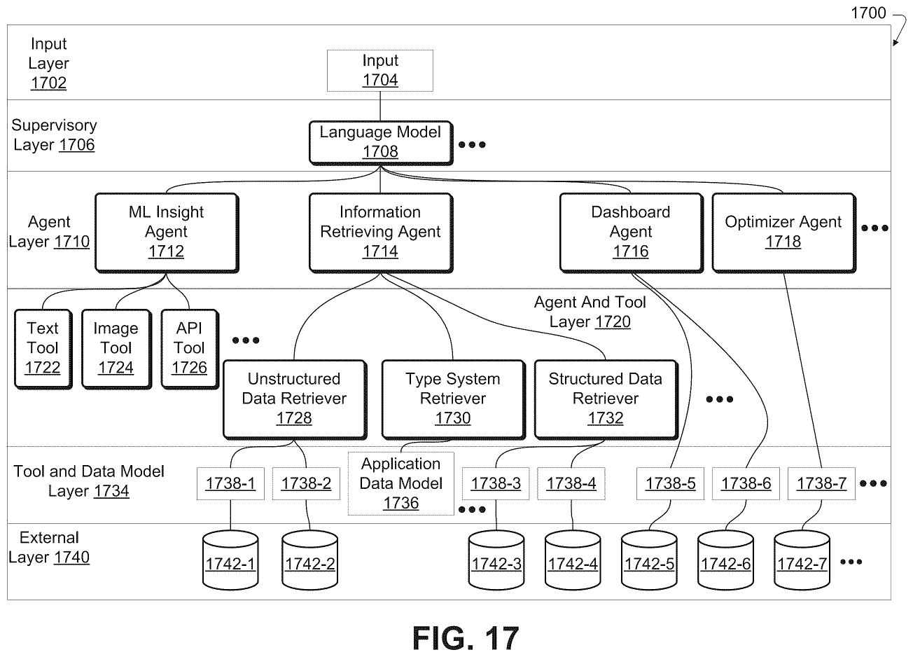

The agents 1604 can select the appropriate tools 1606 to accomplish a set of prescribed tasks (e.g., tasks prescribed by the system). The tools 1606 can make the appropriate function calls to retrieve data from the data sources 1608, which may include unstructured data records (e.g., documents and text data that is stored on a file system in a format such as PDF, DOCX, .MD, HTML, TXT, PPTX, image files, audio files, video files, application outputs, and the like), structured data records (e.g., database tables or other data records stored according to a data model or type system), timeseries data records (e.g., sensor data, artificial intelligence application insights), and/or other types of data records (e.g., access control lists). The tools 1606 may also be used to perform other operations, such as mathematical operations, data processing operations, and/or the like, such as those described in connection with FIG. 17. The agents 1604 can transform obtained data into a common format (e.g., natural language format) that can be post-processed by a large language model (e.g., the same or different large language model that performed the pre-processing). More specifically, post-processing can take tool outputs (and/or transformed tool outputs) and generate the final result 1610 that satisfies the initial input. For example, the system may use one or more large language models to determine the result. If the system determines there is not enough information to satisfy the initial input, the system can iteratively repeat some or all of the above actions until a stopping condition is satisfied and/or there is enough information to generate the final result 1610. The agents 1604 and/or the tools 1606 may implement, perform, or be used to perform machine learning-based degradation optimization.

FIG. 17 depicts a diagram 1700 of an example layered architecture and environment of an artificial intelligence system to perform operations such as described herein. In the example of FIG. 17, the enterprise generative artificial intelligence system architecture and environment includes a hierarchy of layers. More specifically, the hierarchy of layers includes an input layer 1702, a supervisory layer 1706, an agent layer 1710, an agent and tool layer 1720, a tool and data model layer 1734, and an external layer 1740. It will be appreciated that these layers are shown by way of example, and other examples can include any number of such layers (e.g., any number of layers 1710 and 1720). In some examples, at least one of the layers described in connection with FIG. 17 are implemented using the system 800 of FIG. 8 and/or the device 900 of FIG. 9.

The input layer 1702 represents a layer of the enterprise generative artificial intelligence system architecture that receives an input (e.g., a query, complex input, instruction set, and/or the like) from a user or system. For example, an interface module of the enterprise generative artificial intelligence system may receive the input.

The supervisory layer 1706 represents a layer of the enterprise generative artificial intelligence system architecture that includes one or more large language models (e.g., of an orchestrator module) that can develop a plan for responding to the input received in the input layer 1702. A plan can include a set of prescribed tasks (e.g., retrieval tasks, API call tasks, and the like). In one example, the supervisory layer 1706 can provide pre-processing and post-processing functionality described herein as well as the functionality of the orchestrators and comprehension modules described herein. The supervisory layer 1706 can coordinate with one or more of the subsequent layers 1710-1740 to execute the prescribed set of tasks.

The agent layer 1710 represents a layer of the enterprise generative artificial intelligence system architecture that includes agents that can execute the prescribed set of tasks. In the example of FIG. 17, the agent layer 1710 includes a machine learning insight agent 1712, an information retrieving agent 1714, a dashboard agent 1716, and an optimizer agent 1718. Each of the agents 1712-1718 can include a large language model that provides reasoning functionality for accomplishing their assigned portion of the prescribed set of tasks. More specially, the agents 1712-1718 can instruct the agents and tools of subsequent layers (e.g., layer 1720), of which there could be any number, to execute the tasks. For example, the machine learning insight agent 1712 can instruct the text processing tool 1722 to perform a text processing task (e.g., transform an artificial intelligence application output into natural language), an image processing tool 1724 to perform an image processing task (e.g., generate a natural language summary of an image outputted from artificial intelligence application), a timeseries tool to obtain summarize timeseries data (e.g., timeseries data output from an artificial intelligence application), and an API tool 1726 to perform an API call task (e.g., execute an API call to trigger or access an artificial intelligence application). In some embodiments, the agents 1712-1718 are the same as the agents 1606 described in connection with FIG. 16.

The information retrieving agent 1714 may cooperate with, and/or coordinate, several different agents to perform retrieval tasks. For example, the information retrieving agent 1714 may instruct an unstructured data retriever agent 1728 to receive unstructured data records, a structured data retriever agent 1732 to retrieve structured data records, and a type system retriever agent 1730 to obtain one or more data models (or subsets of data models) and/or types from a type system. The type system provides compatibility across different data formats, protocols, operating languages, disparate systems, etc. Types can encapsulate data formats for some or all of the different types or modalities described herein (e.g., multimodal, text, coded, language, statistical, audio, visual, audiovisual, etc.). For example, a data model may include a variety of different types (e.g., in a tree or graph structure), and each of the types may describe data fields, operations, functions, and the like. Each type can represent a different object (e.g., a real-world object, such as a machine or sensor in a factory) or system (e.g., computing cluster, enterprise datastores, file systems), and each type can include a large language model context that provides context for the large language model to design or update a plan. For example, the context may include a natural language summary or description of the type (e.g., a description of the represented object, relationships with other types or objects, associated methods and functions, and the like). Types can be defined in a natural language format for efficient processing by large language models. The type system retriever agent 1730 may traverse the data model 1736 to retrieve a subset of the data model 1736 and/or types of the data model 1736. The structured data retriever agent 1732 can then use that retrieved information to efficiently retrieve structured data from a structured data source (e.g., a structured data source that is structured or modeled according to the data model 1736).

The dashboard agent 1716 may be configured to generate one or more visualizations and/or graphical user interfaces, such as dashboards. For example, the dashboard agent 1716 may execute tools 1738-5 and 1738-6 to generate dashboards based on information retrieved by the other agents and/or information output by the other agents (e.g., natural language summaries of associated tool outputs).

The optimizer agent 1718 may be configured to execute a variety of different prescriptive analytics functions and mathematical optimizations 1738-7 to assist in the calculation of answers for various problems. For example, the large language model 1708 may use the optimizer agent 1718 to generate plans, determine a set of prescribed tasks, determine whether more information is needed to generate a final result, and the like.

The tool and data model layer 1734 is intended to represent a layer of the enterprise generative artificial intelligence system architecture that includes tools 1738 and the data model 1736. The agents 1728-1732 can execute the tools 1738 to retrieve information from various applications and datastores 1742 in the external layer 1740 (e.g., external relative to the enterprise generative artificial intelligence system). The tools 1738 may include connectors that can connect to systems and datastore that are external to the enterprise generative artificial intelligence system. In an embodiment, one or more layers and/or agents of FIG. 17 may be used to implement or otherwise perform one or more operations such as those described herein. In at least one embodiment, one or more components, agents, models, and/or variations thereof, of each of the input layer 1702, supervisory layer 1706, agent layer 1710, agent and tool layer 1720, tool and data model layer 1734, and/or external layer 1740, implement, perform, or are used to perform machine learning-based degradation optimization.

As will be apparent to one of ordinary skill in the art, other variations are within spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. Use of “may” and/or “can” is intended to indicate by way of example without limiting any particular embodiment or component or other function described above, below, or elsewhere herein. “Connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. Use of term “set” (e.g., “a set of items”) or “subset” unless otherwise noted or contradicted by context, is to be construed as a nonempty collection comprising one or more members. Further, unless otherwise noted or contradicted by context, term “subset” of a corresponding set does not necessarily denote a proper subset of corresponding set, but subset and corresponding set may be equal.

Conjunctive language, such as, but not limited to, phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, term “plurality” indicates a state of being plural (e.g., “a plurality of items” indicates multiple items). Number of items in a plurality can be at least two, but can be more when so indicated either explicitly or by context. Further, unless stated otherwise or otherwise clear from context, phrase “based on” means “based at least in part on” and not “based solely on.”

Operations of processes described herein can be performed in any suitable order unless otherwise indicated herein or otherwise clearly contradicted by context. A process such as, but not limited to, those processes described herein (or variations and/or combinations thereof) can be performed under control of one or more computer systems configured with executable instructions and is implemented as code (e.g., executable instructions, one or more computer programs or one or more applications) executing collectively on one or more processors, by hardware or combinations thereof. Code can be stored on a computer-readable storage medium, for example, in form of a computer program comprising a plurality of instructions executable by one or more processors. A computer-readable storage medium can be a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. Code (e.g., executable code or source code) can be stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. A set of non-transitory computer-readable storage media can include multiple non-transitory computer-readable storage media and one or more of individual non-transitory storage media of multiple non-transitory computer-readable storage media lack all of code while multiple non-transitory computer-readable storage media collectively store all of code. Executable instructions can be executed such that different instructions are executed by different processors—for example, a non-transitory computer-readable storage medium store instructions and a main central processing unit (“CPU”) executes some of instructions while a graphics processing unit (“GPU”) executes other instructions. Different components of a computer system can have separate processors and different processors execute different subsets of instructions.

Computer systems can be configured to implement one or more services that singly or collectively perform operations of processes described herein and such computer systems are configured with applicable hardware and/or software that enable performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or example language (e.g., “such as, but not limited to,”) provided herein, is intended merely to better illuminate embodiments of disclosure and does not pose a limitation on scope of disclosure unless otherwise claimed. No language in specification should be construed as indicating any non-claimed element as essential to practice of disclosure.

All references, including publications, patent applications, and patents, cited herein are hereby incorporated by reference to same extent as if each reference were individually and specifically indicated to be incorporated by reference and were set forth in its entirety herein.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as, but not limited to, “processing,” “computing,” “calculating,” “determining,” or like, refer to action and/or processes of a computer or computing system, or similar electronic computing device, that manipulate and/or transform data represented as physical, such as, but not limited to, electronic, quantities within computing system's registers and/or memories into other data similarly represented as physical quantities within computing system's memories, registers or other such information storage, transmission or display devices.

In a similar manner, term “processor” may refer to any device or portion of a device that processes electronic data from registers and/or memory and transform that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as, but not limited to, tasks, threads, and intelligent agents. Also, each process may refer to multiple processes, for carrying out instructions in sequence or in parallel, continuously, or intermittently. Terms “system” and “method” are used herein interchangeably insofar as system may embody one or more methods and methods may be considered a system.

References may be made to obtaining, acquiring, receiving, or inputting analog or digital data into a subsystem, computer system, or computer-implemented machine. Processes of obtaining, acquiring, receiving, or inputting analog and digital data can be accomplished in a variety of ways such as, but not limited to, by receiving data as a parameter of a function call or a call to an application programming interface. Processes of obtaining, acquiring, receiving, or inputting analog or digital data can be accomplished by transferring data via a serial or parallel interface. Processes of obtaining, acquiring, receiving, or inputting analog or digital data can be accomplished by transferring data via a computer network from providing entity to acquiring entity. References may also be made to providing, outputting, transmitting, sending, or presenting analog or digital data. In various examples, processes of providing, outputting, transmitting, sending, or presenting analog or digital data can be accomplished by transferring data as an input or output parameter of a function call, a parameter of an application programming interface or interprocess communication mechanism.

Although descriptions herein set forth example implementations of described techniques, other architectures may be used to implement described functionality, and are intended to be within scope of this disclosure. Furthermore, although specific distributions of responsibilities may be defined above for purposes of description, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as example forms of implementing the claims.

It will be appreciated that an “engine,” “system,” “datastore,” and/or “database” may comprise software, hardware, firmware, and/or circuitry. In one example, one or more software programs comprising instructions capable of being executable by a processor may perform one or more of the functions of the engines, datastores, databases, or systems described herein. In another example, circuitry may perform the same or similar functions. Alternative embodiments may comprise more, less, or functionally equivalent engines, systems, datastores, or databases, and still be within the scope of present embodiments. For example, the functionality of the various systems, engines, datastores, and/or databases may be combined or divided differently. The datastore or database may include cloud storage. It will further be appreciated that the term “or,” as used herein, may be construed in either an inclusive or exclusive sense. Moreover, plural instances may be provided for resources, operations, or structures described herein as a single instance.

The datastores described herein may be any suitable structure (e.g., an active database, a relational database, a self-referential database, a table, a matrix, an array, a flat file, a documented-oriented storage system, a non-relational No-SQL system, and the like), and may be cloud-based or otherwise.

The systems, methods, engines, datastores, and/or databases described herein may be at least partially processor-implemented, with a particular processor or processors being an example of hardware. For example, at least some of the operations of a method may be performed by one or more processors or processor-implemented engines. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an Application Program Interface (API)).

The performance of certain of the operations may be distributed among the processors, not only residing within a single machine, but deployed across a number of machines. In some example embodiments, the processors or processor-implemented engines may be located in a single geographic location (e.g., within a home environment, an office environment, or a server farm). In other example embodiments, the processors or processor-implemented engines may be distributed across a number of geographic locations.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Example embodiments are described above. It will be apparent to those skilled in the art that various modifications may be made, and other embodiments may be used without departing from the broader scope of possible embodiments. Therefore, these and other variations upon the example embodiments are intended to be covered by the present disclosure.

1. A method comprising:
identifying a power module, wherein the power module is controlled with a set of variables;
determining, using functional relations of degradation of a degradation machine learning model, optimal set-point values that minimize degradation of the power module while utilizing minimal resources; and
reducing a degradation rate of the power module by adjusting one or more of the variables that control the power module based on the determined optimal set-point values.

2. A method comprising:
identifying a plurality of power modules, wherein each power module is controlled with a respective set of a variables and associated variable values;
detecting changes to the associated variable values over time, wherein the associated variable values for a particular power module of the plurality of power modules changes differently relative to other power modules of the plurality of power modules;
learning, by a degradation machine learning model, based on the detected changes over time, how respective sets of variable values differently affect degradation of different power modules of the plurality of power modules;
determining, using functional relations of degradation of the degradation machine learning model, optimal set-point values that minimize an overall degradation rate of the plurality of power modules while utilizing minimal resources; and
enabling reduction of the overall degradation rate of the plurality of power modules by adjusting one or more of the respective sets of variables that control the plurality of power modules based on the determined optimal set-point values.

3. The method of claim 2, wherein each of the plurality of power modules are of a same type of power module.

4. The method of claim 2, wherein the plurality of power modules includes different types of power modules.

5. The method of claim 2, further comprising:
generating a respective digital twin for each of the plurality of power modules, wherein the digital twins comprise a library of different machine learning models associated with different operating conditions of the power modules, and wherein the learning is performed based on the digital twins.

6. The method of claim 2, further comprising retraining degradation machine learning models to capture latest or current variable values and learn from the changes to the associated variable values over time.

7. The method of claim 2, wherein the set of variables includes any of temperature, current, voltage, fuel, air, and/or geographic location.

8. The method of claim 2, wherein a power module comprises any of a power cell, battery, and other power source.

9. The method of claim 2, further comprising:
predicting, by the degradation machine learning model based on historical variable values, a respective rate of degradation for each of the plurality of power modules.

10. The method of claim 2, wherein enabling reduction of the overall degradation rate of the plurality of power modules includes removing one or more of the plurality of power modules from the plurality of power modules.

11. The method of claim 2, wherein the plurality of power modules includes any number of power modules.

12. The method of claim 2, wherein the enabling reduction is at least partially performed by an optimizer.

13. The method of claim 2, wherein at least a portion of the associated variable values include time series values.

14. A system comprising:
one or more processors; and
memory storing instructions that, when executed by the one or more processors, cause the system to perform:
identifying a power module, wherein the power module is controlled with a set of variables;
determining, using functional relations of degradation of a degradation machine learning model, optimal set-point values that minimize degradation of the power module while utilizing minimal resources; and
enabling reduction of a degradation rate of the power module by adjusting one or more of the set of variables that control the power module based on the determined optimal set-point values.

15. The system of claim 14, wherein the instructions, when executed by the one or more processors, also cause the system to perform:
identifying a plurality of additional power modules, wherein each additional power module is controlled with a respective additional set of variables and associated variable values;
detecting changes to the associated variable values over time, wherein the associated variable values for a particular power module changes differently relative to other power modules of the plurality of additional power modules;
learning, by a degradation machine learning model, based on the detected changes over time, how respective sets of variable values differently affect degradation of different power modules of the plurality of additional power modules;
determining, using functional relations of degradation of the degradation machine learning model, additional optimal set-point values that minimize an overall degradation rate of the plurality of additional power modules while utilizing minimal resources; and
enabling reduction of the overall degradation rate of the plurality of additional power modules by adjusting one or more of the respective additional sets of variables that control the plurality of additional power modules based on the determined additional optimal set-point values.
